(19) United States
(12) Patent Application Publication
(10) Pub. No.: US 2025/0366662 A1
(43) Pub. Date: Dec. 4, 2025

(54) ELECTRIC GRILLS INCLUDING CONVECTION FANS

(71) Applicant: Weber-Stephen Products LLC, Palatine, IL (US)

(72) Inventors: Sean A. Yakes, Elgin, IL (US); Jeffrey C. Penteris, Hawthorn Woods, IL (US); Kevin J. Schmeski, Romeoville, IL (US)

(21) Appl. No.: 19/032,559

(22) Filed: Jan. 21, 2025

Related U.S. Application Data
(60) Provisional application No. 63/653,608, filed on May 30, 2024.

(51) Int. Cl. A47J 37/07; A47J 36/32; A47J 37/06; A47J 39/02; F04D 13/06; F04D 13/12; F04D 29/70; F24C 7/08; F24C 15/18; F24C 15/32

(52) U.S. Cl. CPC A47J 37/0754; A47J 36/32; A47J 37/0641; A47J 37/0709; A47J 39/02; F04D 13/06; F04D 13/12; F04D 29/703; F24C 7/087; F24C 15/18; F24C 15/325

(57) ABSTRACT

Electric grills including convection fans are disclosed. An example electric grill includes a cookbox, a lid, a cooking chamber, a first heating element, a second heating element, a first convection fan, and a second convection fan. The cooking chamber is defined by the cookbox and the lid. The cooking grate is located within the cooking chamber. The first and second heating elements are respectively located within the cooking chamber below the cooking grate. The second heating element is laterally offset from the first heating element. The first and second convection fans are respectively coupled to a rear wall of the cookbox, located above corresponding ones of the first and second heating elements, and located at least partially within the cooking chamber. The second convection fan is laterally offset from the first convection fan.

### RELATED APPLICATIONS

This application claims priority to U.S. Provisional Patent Application No. 63/653,608, filed May 30, 2024. The entirety of U.S. Provisional Patent Application No. 63/653,608 is hereby incorporated by reference herein.

### FIELD OF THE DISCLOSURE

This disclosure relates generally to electric grills and, more specifically, to electric grills including convection fans.

### BACKGROUND

Electric grills typically include a cookbox, a lid configured to cover the cookbox so as to form a cooking chamber, and one or more electrically-powered heating element(s) located within the cookbox and/or within the cooking chamber. Electric grills also typically include one or more cooking surface(s) located within the cookbox and/or within the cooking chamber at a position above and/or over the electrically-powered heating element(s). The cooking surface(s) is/are typically implemented as one or more grilling grate(s) that is/are configured to support one or more item(s) of food to be grilled within the cooking chamber of the electric grill. Conventional electric grills of the type described above typically rely on radiation and/or conduction associated with the heat generated by the electrically-powered heating element(s) as a means to cook (e.g., grill) any item(s) of food that may be located on the cooking surface(s) within the cooking chamber of the electric grill.

### BRIEF DESCRIPTION OF THE DRAWINGS

FIG. 1 is a block diagram of an example electric grill constructed in accordance with the teachings of this disclosure.

FIG. 2 is a perspective view of an example first implementation of the electric grill of FIG. 1, with an example lid of the electric grill shown in an example closed position relative to an example cookbox of the electric grill.

FIG. 3 is a perspective view of the electric grill as shown in FIG. 2, with the lid of the electric grill shown in an example open position relative to the cookbox of the electric grill.

FIG. 4 is a front view of the electric grill as shown in FIG. 2.

FIG. 5 is a rear view of the electric grill as shown in FIGS. 2 and 4.

FIG. 6 is a top view of the electric grill as shown in FIGS. 2, 4, and 5.

FIG. 7 is a top view of the electric grill as shown in FIGS. 2 and 4-6, with the lid of the electric grill omitted.

FIG. 8 is a top view of the electric grill as shown in FIGS. 2 and 4-6, with the lid, an example exterior fan guard, and an example interior fan guard of the electric grill omitted.

FIG. 9 is an enlarged view of a portion of FIG. 8.

FIG. 10 is a cross-sectional view of the electric grill as shown in FIGS. 2 and 4-6, taken along section A-A of FIG. 6.

FIG. 11 is a cross-sectional view of the electric grill as shown in FIGS. 2 and 4-6, taken along section B-B of FIG. 6.

FIG. 12 is a front view of an example second implementation of the electric grill of FIG. 1.

FIG. 13 is a front view of an example third implementation of the electric grill of FIG. 1.

FIG. 14 is a flowchart representative of example machine-readable instructions and/or example operations that may be executed by processor circuitry to implement the electric grill of FIG. 1.

FIG. 15 is a block diagram of an example processor platform including processor circuitry structured to execute and/or instantiate the machine-readable instructions and/or operations of FIG. 14 to implement the electric grill of FIG. 1.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

As discussed above, conventional electric grills typically rely on radiation and/or conduction associated with heat generated by one or more electrically-powered heating element(s) as a means to cook (e.g., grill) any item(s) of food that may be located on one or more cooking surface(s) located within a cooking chamber of the electric grill. Unlike such conventional electric grills, example electric grills disclosed herein include one or more convection fan(s) that facilitate the implementation of one or more convection-based cooking process(es) within a cooking chamber of the electric grill.

In some disclosed examples, an electric grill includes a cookbox, a lid, a cooking chamber, a cooking grate, a first heating element, a second heating element, a first convection fan, and a second convection fan. The cookbox includes a rear wall. The lid is movable relative to the cookbox between a closed position and an open position. The cooking chamber is defined by the cookbox and the lid. The cooking grate is located within the cooking chamber. The first and second heating elements are located within the cooking chamber below the cooking grate, with the second heating clement being laterally offset from the first heating element. The first and second convection fans are coupled to the rear wall of the cookbox. The first convection fan is located above the first heating element and at least partially within the cooking chamber. The second convection fan is located above the second heating element and at least partially within the cooking chamber, with the second convection fan being laterally offset from the first convection fan.

In some disclosed examples, the electric grill further includes a controller in electrical communication with the first heating element, the second heating element, the first convection fan, and the second convection fan. The controller is configured to independently control the first heating element, the second heating element, the first convection fan, and the second convection fan. In some disclosed examples, the electric grill further includes a power supply configured to supply electric power to the first heating element, the second heating element, the first convection fan, and the second convection fan.

In some disclosed examples, the first and second convection fans are located above the cooking grate. In some disclosed examples, the first convection fan is laterally aligned with the first heating element, and the second convection fan is laterally aligned with the second heating element. In some disclosed examples, the first heating element and the first convection fan provide a first controllable cooking zone within the cooking chamber, and the second heating clement and the second convection fan provide a second controllable cooking zone within the cooking chamber, with the second controllable cooking zone being laterally offset from the first controllable cooking zone.

In some disclosed examples, the cookbox of the electric grill supports the cooking grate, the first heating element, the second heating clement, the first convection fan, and the second convection fan. In some disclosed examples, the first convection fan includes a first plurality of blades located within the cooking chamber, and the second convection fan includes a second plurality of blades located within the cooking chamber. In some disclosed examples, the first convection fan includes a first motor located at least partially outside of the cooking chamber, and the second convection fan includes a second motor located at least partially outside of the cooking chamber. In some disclosed examples, a portion of the first convection fan and a portion of the second convection fan respectively extend through the rear wall of the cookbox.

In some disclosed examples, the electric grill further includes an interior fan guard located within the cooking chamber. The interior fan guard is configured to cover at least one of the first plurality of blades of the first convection fan or the second plurality of blades of the second convection fan. In some disclosed examples, the interior fan guard is coupled to the rear wall of the cookbox. In some disclosed examples, the electric grill further includes an exterior fan guard located externally to the cooking chamber. The exterior fan guard is configured to cover at least one of the first motor of the first convection fan or the second motor of the second convection fan. In some disclosed examples, the exterior fan guard is coupled to the rear wall of the cookbox.

In some disclosed examples, the electric grill further includes a warming cabinet. The warming cabinet is spaced apart and thermally isolated from the cooking chamber of the electric grill. A heating element is located within the warming cabinet. A controller is in electrical communication with the first heating element, the second heating element, the first convection fan, and the second convection fan of the cooking chamber, and is further in electrical communication with the heating element of the warming cabinet. The controller is configured to independently control the first heating element, the second heating element, the first convection fan, and the second convection fan of the cooking chamber, and to further independently control the heating element of the warming cabinet. In some disclosed examples, at least one of the first heating clement, the second heating clement, the first convection fan, or the second convection fan of the cooking chamber is concurrently operable with the heating element of the warming cabinet.

In some disclosed examples, the electric grill further includes an air fryer. The air fryer is spaced apart and thermally isolated from the cooking chamber of the electric grill. A heating element is located within the air fryer. A convection fan is located at least partially within the air fryer. A controller is in electrical communication with the first heating element, the second heating element, the first convection fan, and the second convection fan of the cooking chamber, and is further in electrical communication with the heating element and the convection fan of the air fryer. The controller is configured to independently control the first heating element, the second heating element, the first convection fan, and the second convection fan of the cooking chamber, and to further independently control the heating element and the convection fan of the air fryer. In some disclosed examples, at least one of the first heating element, the second heating element, the first convection fan, or the second convection fan of the cooking chamber is concurrently operable with at least one of the heating element or the convection fan of the air fryer.

The above-identified features as well as other advantageous features of example electric grills including convection fans are further described below in connection with the figures of the application.

As used herein in a mechanical context, the term “configured” means sized, shaped, arranged, structured, oriented, positioned, and/or located. For example, in the context of a first part configured to fit within a second part, the first part is sized, shaped, arranged, structured, oriented, positioned, and/or located to fit within the second part. As used herein in an electrical and/or computing context, the term “configured” means arranged, structured, and/or programmed. For example, in the context of processor circuitry configured to perform a specified operation, the processor circuitry is arranged, structured, and/or programmed (e.g., based on machine-readable instructions) to perform the specified operation.

As used herein in the context of a first object circumscribing a second object, the term “circumscribe” means that the first object is constructed around and/or defines an area around the second object. In interpreting the term “circumscribe” as used herein, it is to be understood that the first object circumscribing the second object can include gaps and/or can consist of multiple spaced-apart objects, such that a boundary formed by the first object around the second object is not necessarily a continuous boundary.

As used herein, unless otherwise stated, the terms “above” and “below” describe the relationship of two parts relative to Earth. For example, as used herein, a first part is “above” a second part if the second part is closer to Earth than the first part is. As another example, as used herein, a first part is “below” a second part if the first part is closer to Earth than the second part is. It is to be understood that a first part can be above or below a second part with one or more of: another part or parts therebetween; without another part therebetween; with the first and second parts contacting one another; or without the first and second parts contacting one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts at the point (or points) of contact between the two parts.

As used herein, the term “fastener” means any device(s), structure(s), and/or material(s) that is/are configured, individually or collectively, to couple, connect, attach, and/or fasten one or more component(s) to one or more other component(s). For example, a fastener can be implemented by any type(s) and/or any number(s) of bolts, nuts, screws, posts, anchors, rivets, pins, clips, ties, welds, adhesives, etc.

As used herein, the term “in electrical communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuit(s) structured to perform one or more specific operation(s), and/or (ii) one or more general purpose electrical circuit(s) programmable with instructions to perform one or more specific operation(s). Example processor circuitry described herein can include any type(s) and/or any number(s) of processor(s), microprocessor(s), controller(s), microcontroller(s), application specific integrated circuit(s) (ASIC(s)), programmable logic device(s) (PLD(s)), field programmable logic device(s), (FPLD(s)), field programmable gate arrays (FPGA(s)), digital signal processor(s) (DSP(s)), graphics processing unit(s) (GPU(s)), central processor unit(s) (CPU(s)), semiconductor-based (e.g., silicon-based) circuit(s), digital circuit(s), analog circuit(s), logic circuit(s), and/or integrated circuit(s) implemented via any type(s) and/or any number(s) of transistor(s), capacitor(s), diode(s), inductor(s), resistor(s), timer(s), counter(s), printed circuit board(s), connector(s), wire(s), and/or other electrical circuit component(s).

As used herein, the terms “non-transitory computer-readable medium” and “non-transitory computer-readable storage medium” are expressly defined to include any type of computer-readable storage device and/or storage disk and to exclude propagating signals and to exclude transmission media.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

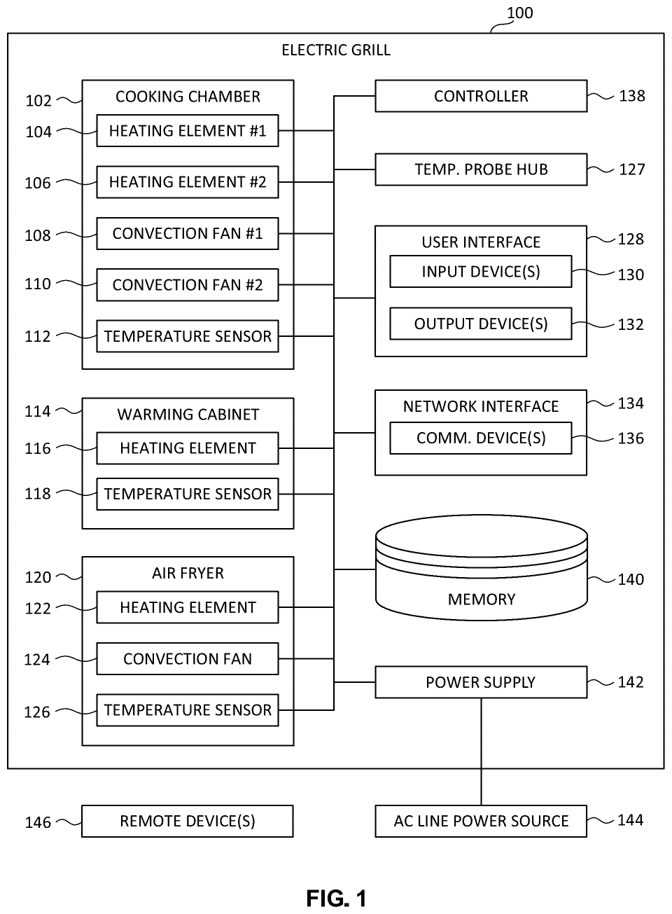

FIG. 1 is a block diagram of an example electric grill 100 constructed in accordance with the teachings of this disclosure. The electric grill 100 of FIG. 1 includes an example cooking chamber 102 (e.g., including an example first heating element 104, an example second heating element 106, an example first convection fan 108, an example second convection fan 110, and an example temperature sensor 112), an example warming cabinet 114 (e.g., including an example heating element 116 and an example temperature sensor 118), an example air fryer 120 (e.g., including an example heating element 122, an example convection fan 124, and an example temperature sensor 126), an example temperature probe hub 127, an example user interface 128 (e.g., including one or more example input device(s) 130 and one or more example output device(s) 132), an example network interface 134 (e.g., including one or more example communication device(s) 136), an example controller 138, example memory 140, and an example power supply 142. In other examples, one or more of the aforementioned components (e.g., the warming cabinet 114, the air fryer 120, etc.) of FIG. I can be omitted from the electric grill 100. In still other examples, the electric grill 100 can include one or more other component(s) in addition to or in lieu of the aforementioned components of FIG. 1. The electric grill 100 of FIG. 1 is configured to communicate (e.g., wirelessly communicate) with one or more example remote device(s) 146, as further described below.

The cooking chamber 102 of the electric grill 100 of FIG. 1 is configured to cook (e.g., grill) one or more item(s) of food contained therein. In some examples, the cooking chamber 102 is defined by a cookbox and a lid of the electric grill 100, with the lid being movable relative to the cookbox between a closed position and an open position. In such examples, the cooking chamber 102 becomes accessible to a user of the electric grill 100 when the lid of the electric grill 100 is moved from a closed position toward or into an open position. Conversely, the cooking chamber 102 is generally inaccessible to the user of the electric grill 100 when the lid of the electric grill is in the closed position. User access to the cooking chamber 102 of the electric grill 100 may periodically become necessary, for example, to add an item of food to the cooking chamber 102 (e.g., at or toward the beginning of a cooking process), to remove an item of food from the cooking chamber 102 (e.g., at or toward the end of a cooking process), and/or to flip, rotate, relocate, or otherwise move an item of food within the cooking chamber 102 (e.g., during the middle of a cooking process). The cooking chamber 102 of the electric grill 100 can be of any configuration suitable for supporting, holding, and/or containing one or more cooking surface(s) (e.g., one or more cooking grate(s)) to be located therein, and/or suitable for supporting, holding, and/or containing one or more item(s) of food to be cooked therein.

The first heating element 104 of the cooking chamber 102 of FIG. 1 generates heat within the cooking chamber 102 of the electric grill 100 in response to electrical power (e.g., electrical current) supplied to the first heating element 104 via the power supply 142 of the electric grill 100. The first heating clement 104 of the cooking chamber 102 can have any configuration (e.g., any combination of linear, curved, and/or serpentine segments) suitable for generating heat at, and/or distributing heat to, one or more desired location(s) within the cooking chamber 102 of the electric grill 100. In some examples, the first heating element 104 of the cooking chamber 102 is configured to generate heat at, and/or to distribute heat to, a specific cooking zone located within the cooking chamber 102 of the electric grill 100, such as a first cooking zone located within a right half of the cooking chamber 102 (e.g., located adjacent to, proximate to, or toward a right side of the cooking chamber 102).

The second heating element 106 of the cooking chamber 102 of FIG. 1 generates heat within the cooking chamber 102 of the electric grill 100 in response to electrical power (e.g., electrical current) supplied to the second heating element 106 via the power supply 142 of the electric grill 100. The second heating element 106 of the cooking chamber 102 can have any configuration (e.g., any combination of linear, curved, and/or serpentine segments) suitable for generating heat at, and/or distributing heat to, one or more desired location(s) within the cooking chamber 102 of the electric grill 100. In some examples, the second heating element 106 of the cooking chamber 102 is configured to generate heat at, and/or to distribute heat to, a specific cooking zone located within the cooking chamber 102 of the electric grill 100, such as a second cooking zone located within a left half of the cooking chamber 102 (e.g., located adjacent to, proximate to, or toward a left side of the cooking chamber 102).

In the illustrated example of FIG. 1, the cooking chamber 102 includes two heating elements (e.g., the first heating element 104 and the second heating element 106). In other examples, the cooking chamber 102 can instead include a different number (e.g., one, three, four, etc.) of heating elements. For example, the cooking chamber 102 can include a third heating element located between the first heating element 104 and the second heating element 106 of the cooking chamber 102.

The first convection fan 108 of the cooking chamber 102 of FIG. 1 generates an airflow within the cooking chamber 102 of the electric grill 100. In some examples, the first convection fan 108 of the cooking chamber 102 is implemented as a DC-powered, variable speed fan that is powered by the power supply 142 of the electric grill 100. In some examples, the first convection fan 108 of the cooking chamber 102 is configured to generate an airflow to, toward, and/or within a specific cooking zone located within the cooking chamber 102 of the electric grill 100, such as a first cooking zone located within a right half of the cooking chamber 102 (e.g., located adjacent to, proximate to, or toward a right side of the cooking chamber 102).

The first convection fan 108 of the cooking chamber 102 of FIG. 1 is preferably coupled and/or mounted to a rear wall of a cookbox that defines the cooking chamber 102 of the electric grill 100. In some examples, the first convection fan 108 of the cooking chamber 102 includes an electric motor, a rotatable shaft operatively coupled to the electric motor, and a plurality of blades operatively coupled to the rotatable shaft. In some such examples, the blades of the first convection fan 108 are located within the cooking chamber 102, and the electric motor of the first convection fan 108 is located at least partially outside of (e.g., external to) the cooking chamber 102. In some such examples, the rotatable shaft of the first convection fan 108 extends through the rear wall of the cookbox that defines the cooking chamber 102 of the electric grill 100.

The second convection fan 110 of the cooking chamber 102 of FIG. 1 generates an airflow within the cooking chamber 102 of the electric grill 100. In some examples, the second convection fan 110 of the cooking chamber 102 is implemented as a DC-powered, variable speed fan that is powered by the power supply 142 of the electric grill 100. In some examples, the second convection fan 110 of the cooking chamber 102 is configured to generate an airflow to, toward, and/or within a specific cooking zone located within the cooking chamber 102 of the electric grill 100, such as a second cooking zone located within a left half of the cooking chamber 102 (e.g., located adjacent to, proximate to, or toward a left side of the cooking chamber 102).

The second convection fan 110 of the cooking chamber 102 of FIG. 1 is preferably coupled and/or mounted to a rear wall of a cookbox that defines the cooking chamber 102 of the electric grill 100. In some examples, the second convection fan 110 of the cooking chamber 102 includes an electric motor, a rotatable shaft operatively coupled to the electric motor, and a plurality of blades operatively coupled to the rotatable shaft. In some such examples, the blades of the second convection fan 110 are located within the cooking chamber 102, and the electric motor of the second convection fan 110 is located at least partially outside of (e.g., external to) the cooking chamber 102. In some such examples, the rotatable shaft of the second convection fan 110 extends through the rear wall of the cookbox that defines the cooking chamber 102 of the electric grill 100.

In the illustrated example of FIG. 1, the cooking chamber 102 includes two convection fans (e.g., the first convection fan 108 and the second convection fan 110). In other examples, the cooking chamber 102 can instead include a different number (e.g., one, three, four, etc.) of convection fans. For example, the cooking chamber 102 can include a third convection fan located between the first convection fan 108 and the second convection fan 110 of the cooking chamber 102. In the illustrated example of FIG. 1, the cooking chamber 102 includes an equal number of heating elements and convection fans (e.g., two heating elements and two convection fans). In other examples, the cooking chamber 102 can instead include a greater number of heating elements than convection fans (e.g., two heating elements and one convection fan, three heating elements and two convection fans, etc.). In still other examples, the cooking chamber 102 can instead include a greater number of convection fans than heating elements (e.g., two convection fans and one heating element, three convection fans and two heating elements, etc.).

The temperature sensor 112 of the cooking chamber 102 of FIG. 1 senses, measures, and/or detects the temperature within the cooking chamber 102 of the electric grill 100. In some examples, the temperature sensor 112 is implemented by and/or as a thermocouple coupled and/or mounted to a cookbox (or to a lid) that defines the cooking chamber 102 of the electric grill 100. In some such examples, a sensing portion (e.g., a sensing tip) of the thermocouple extends into and/or is located within the cooking chamber 102 of the electric grill 100. Data, information, and/or signals sensed, measured, and/or detected by the temperature sensor 112 of the cooking chamber 102 can be of any quantity, type, form, and/or format. Data, information, and/or signals sensed, measured, and/or detected by the temperature sensor 112 of the cooking chamber 102 can be transmitted directly to the controller 138 of FIG. 1, and/or can be transmitted to and stored in the memory 140 of FIG. 1.

In the illustrated example of FIG. 1, the cooking chamber 102 includes a single (e.g., one) temperature sensor (e.g., the temperature sensor 112). In other examples, the cooking chamber 102 can instead include a different number (e.g., two, three, four, etc.) of temperature sensors. For example, the cooking chamber 102 can include a second temperature sensor in addition to the temperature sensor 112 of FIG. 1. In such an example, the temperature sensor 112 can be positioned within a first cooking zone located within a right half of the cooking chamber 102 (e.g., located adjacent to, proximate to, or toward a right side of the cooking chamber 102), and the second temperature sensor can be positioned within a second cooking zone located within a left half of the cooking chamber 102 (e.g., located adjacent to, proximate to, or toward a left side of the cooking chamber 102).

In some examples, the cooking chamber 102 of FIG. 1 includes a cooking grate configured to support one or more item(s) of food within the cooking chamber 102. In some such examples, the first heating element 104 and the second heating element 106 are located within the cooking chamber 102 below the cooking grate, with the second heating element 106 being laterally offset from (e.g., located to the left of) the first heating element 104. In some such examples, the first convection fan 108 and the second convection fan 110 are located within the cooking chamber 102 above the cooking grate, with the second convection fan 110 being laterally offset from (e.g., located to the left of) the first convection fan 108. In some such examples, the first convection fan 108 is laterally aligned with the first heating element 104, and the second convection fan 110 is laterally aligned with the second heating element 106. In some such examples, the first heating element 104 and the first convection fan 108 provide a first controllable cooking zone within the cooking chamber 102, and the second heating element 106 and the second convection fan 110 provide a second controllable cooking zone within the cooking chamber 102, with the second controllable cooking zone being laterally offset from (e.g., located to the left of) the first controllable cooking zone. In some examples, a cookbox that defines the cooking chamber 102 of the electric grill 100 of FIG. 1 supports the cooking grate, the first heating element 104, the second heating element 106, the first convection fan 108, the second convection fan 110, and the temperature sensor 112, each of which is located at least partially within the cooking chamber 102.

The warming cabinet 114 of the electric grill 100 of FIG. 1 is configured to warm and/or otherwise maintain the temperature of one or more item(s) of food contained therein. The warming cabinet 114 of the electric grill 100 is spaced apart from and/or thermally isolated from the cooking chamber 102 of the electric grill 100 such that changes in the thermal state (e.g., the temperature) within the cooking chamber 102 do not directly impact the thermal state (e.g., the temperature) within the warming cabinet 114, and vice-versa. Operations of the electric grill 100 involving and/or performed within the warming cabinet 114 occur independently of operations of the electric grill 100 involving and/or performed within the cooking chamber 102. The warming cabinet 114 of the electric grill 100 can be of any configuration suitable for supporting, holding, and/or containing one or more warming surface(s) (e.g., one or more warming rack(s)) to be located therein, and/or suitable for supporting, holding, and/or containing one or more item(s) of food to be warmed therein.

The heating element 116 of the warming cabinet 114 of FIG. I generates heat within the warming cabinet 114 of the electric grill 100 in response to electrical power (e.g., electrical current) supplied to the heating element 116 via the power supply 142 of the electric grill 100. The heating element 116 of the warming cabinet 114 can have any configuration (e.g., any combination of linear, curved, and/or serpentine segments) suitable for generating heat at, and/or distributing heat to, one or more desired location(s) within the warming cabinet 114 of the electric grill 100. In some examples, the heating element 116 of the warming cabinet 114 is horizontally oriented and located at, adjacent to, or proximate to a lower (e.g., bottom) interior wall of the warming cabinet 114. In other examples, the heating element 116 of the warming cabinet 114 is vertically oriented and located at, adjacent to, or proximate to a rear interior wall, a right side interior wall, or a left side interior wall of the warming cabinet 114.

In the illustrated example of FIG. 1, the warming cabinet 114 includes a single (e.g., one) heating element (e.g., the heating element 116). In other examples, the warming cabinet 114 can instead include a different number (e.g., two, three, four, etc.) of heating elements. For example, the warming cabinet 114 can include a second heating element in addition to the heating element 116 of FIG. 1.

The temperature sensor 118 of the warming cabinet 114 of FIG. 1 senses, measures, and/or detects the temperature within the warming cabinet 114 of the electric grill 100. In some examples, the temperature sensor 118 is implemented by and/or as a thermocouple coupled and/or mounted to an interior wall of the warming cabinet 114 of the electric grill 100. In some such examples, a sensing portion (e.g., a sensing tip) of the thermocouple extends into and/or is located within the warming cabinet 114 of the electric grill 100. Data, information, and/or signals sensed, measured, and/or detected by the temperature sensor 118 of the warming cabinet 114 can be of any quantity, type, form, and/or format. Data, information, and/or signals sensed, measured, and/or detected by the temperature sensor 118 of the warming cabinet 114 can be transmitted directly to the controller 138 of FIG. 1, and/or can be transmitted to and stored in the memory 140 of FIG. 1.

In the illustrated example of FIG. 1, the warming cabinet 114 includes a single (e.g., one) temperature sensor (e.g., the temperature sensor 118). In other examples, the warming cabinet 114 can instead include a different number (e.g., two, three, four, etc.) of temperature sensors. For example, the warming cabinet 114 can include a second temperature sensor in addition to the temperature sensor 118 of FIG. 1.

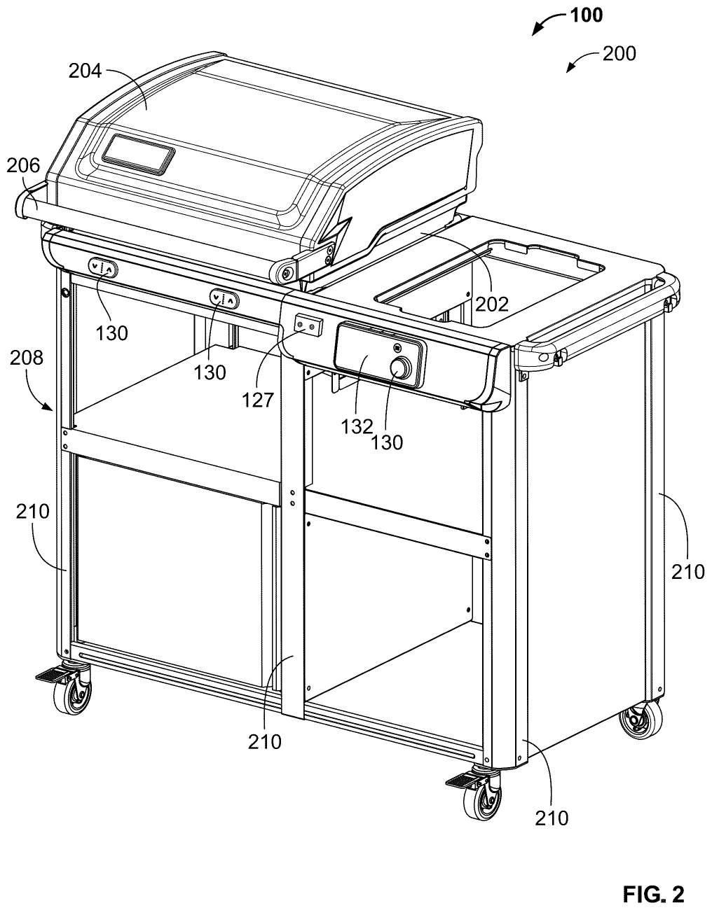

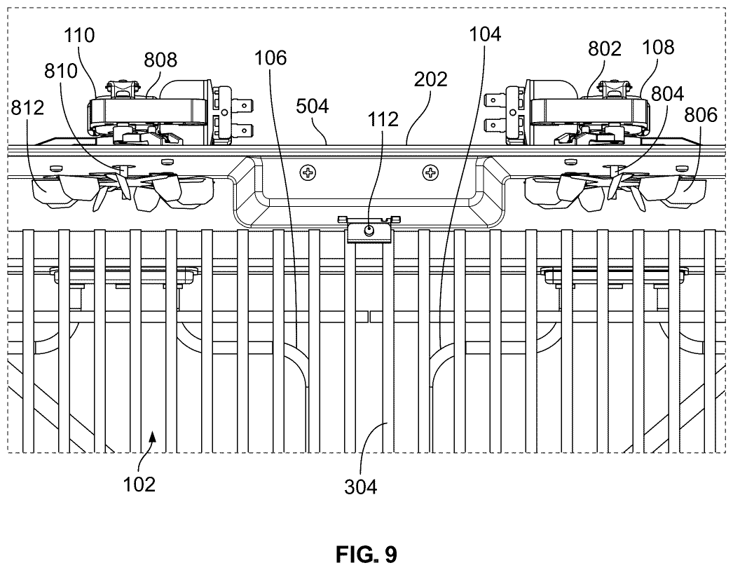

Embodiments of the electric grill 100 of FIG. I can be implemented with or without the warming cabinet 114. Thus, some embodiments of the electric grill 100 of FIG. 1 may include the warming cabinet 114, while other embodiments of the electric grill 100 of FIG. 1 may omit the warming cabinet 114. By way of example, the embodiments of the electric grill 100 illustrated in FIGS. 9-12 described herein include the warming cabinet 114, while the embodiment of the electric grill 100 illustrated in FIGS. 2-8 described herein does not include the warming cabinet 114.

The air fryer 120 of the electric grill 100 of FIG. 1 is configured to air fry one or more item(s) of food contained therein. The air fryer 120 of the electric grill 100 is spaced apart from and/or thermally isolated from both the cooking chamber 102 and the warming cabinet 114 of the electric grill 100, such that changes in the thermal state (e.g., the temperature) within the cooking chamber 102 and/or the warming cabinet 114 do not directly impact the thermal state (e.g., the temperature) within the air fryer 120, and vice-versa. Operations of the electric grill 100 involving and/or performed within the air fryer 120 occur independently of operations of the electric grill 100 involving and/or performed within the cooking chamber 102 and/or the warming cabinet 114. The air fryer 120 of the electric grill 100 can be of any configuration suitable for supporting, holding, and/or containing one or more air frying surface(s) (e.g., one or more perforated tray(s) and/or perforated basket(s)) to be located therein, and/or suitable for supporting, holding, and/or containing one or more item(s) of food to be air fried therein.

The heating element 122 of the air fryer 120 of FIG. 1 generates heat within the air fryer 120 of the electric grill 100 in response to electrical power (e.g., electrical current) supplied to the heating element 122 via the power supply 142 of the electric grill 100. The heating element 122 of the air fryer 120 can have any configuration (e.g., any combination of linear, curved, and/or serpentine segments) suitable for generating heat at, and/or distributing heat to, one or more desired location(s) within the air fryer 120 of the electric grill 100. In some examples, the heating element 122 of the air fryer 120 is horizontally oriented and located at, adjacent to, or proximate to an upper (e.g., top) interior wall of the air fryer 120. In other examples, the heating element 122 of the air fryer 120 is vertically oriented and located at, adjacent to, or proximate to a rear interior wall, a right side interior wall, or a left side interior wall of the air fryer 120.

In the illustrated example of FIG. 1, the air fryer 120 includes a single (e.g., one) heating element (e.g., the heating element 122). In other examples, the air fryer 120 can instead include a different number (e.g., two, three, four, etc.) of heating elements. For example, the air fryer 120 can include a second heating element in addition to the heating element 122 of FIG. 1.

The convection fan 124 of the air fryer 120 of FIG. 1 generates an airflow within the air fryer 120 of the electric grill 100. In some examples, the convection fan 124 of the air fryer 120 is implemented as a DC-powered, variable speed fan that is powered by the power supply 142 of the electric grill 100. In some examples, the convection fan 124 of the air fryer 120 is horizontally oriented and located at, adjacent to, or proximate to an upper (e.g., top) interior wall of the air fryer 120. In other examples, the convection fan 124 of the air fryer 120 is vertically oriented and located at, adjacent to, or proximate to a rear interior wall, a right side interior wall, or a left side interior wall of the air fryer 120.

In the illustrated example of FIG. 1, the air fryer 120 includes a single (e.g., one) convection fan (e.g., the convection fan 124). In other examples, the air fryer 120 can instead include a different number (e.g., two, three, four, etc.) of convection fans. For example, the air fryer 120 can include a second convection fan in addition to the convection fan 124 of FIG. 1.

The temperature sensor 126 of the air fryer 120 of FIG. 1 senses, measures, and/or detects the temperature within the air fryer 120 of the electric grill 100. In some examples, the temperature sensor 126 is implemented by and/or as a thermocouple coupled and/or mounted to an interior wall of the air fryer 120 of the electric grill 100. In some such examples, a sensing portion (e.g., a sensing tip) of the thermocouple extends into and/or is located within the air fryer 120 of the electric grill 100. Data, information, and/or signals sensed, measured, and/or detected by the temperature sensor 126 of the air fryer 120 can be of any quantity, type, form, and/or format. Data, information, and/or signals sensed, measured, and/or detected by the temperature sensor 126 of the air fryer 120 can be transmitted directly to the controller 138 of FIG. 1, and/or can be transmitted to and stored in the memory 140 of FIG. 1.

In the illustrated example of FIG. 1, the air fryer 120 includes a single (e.g., one) temperature sensor (e.g., the temperature sensor 126). In other examples, the air fryer 120 can instead include a different number (e.g., two, three, four, etc.) of temperature sensor. For example, the air fryer 120 can include a second temperature sensor in addition to the temperature sensor 126 of FIG. 1.

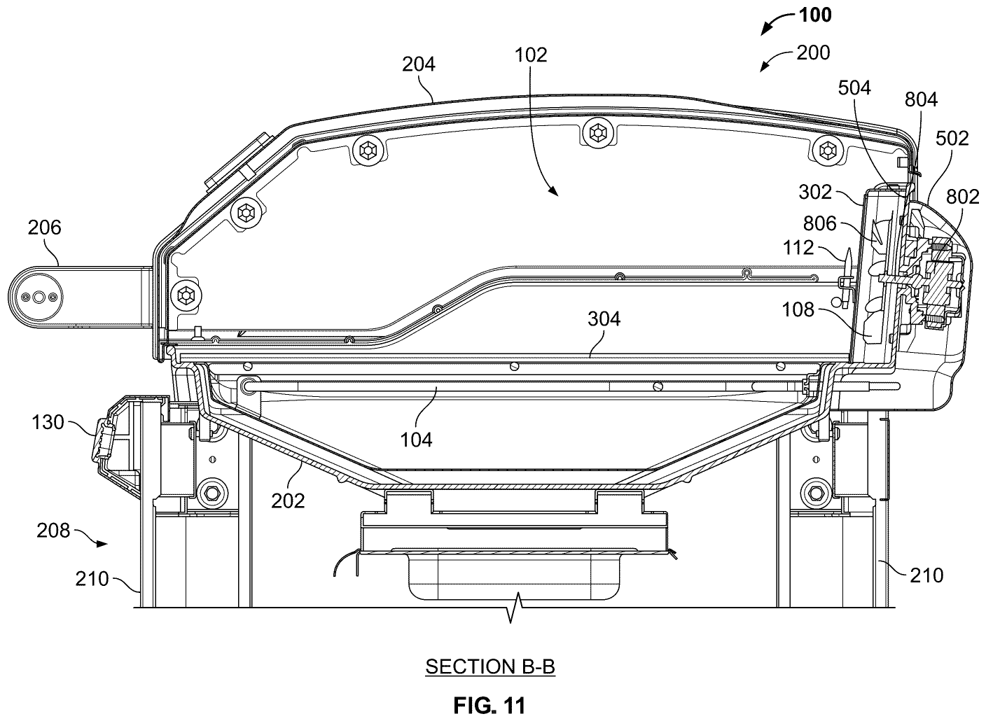

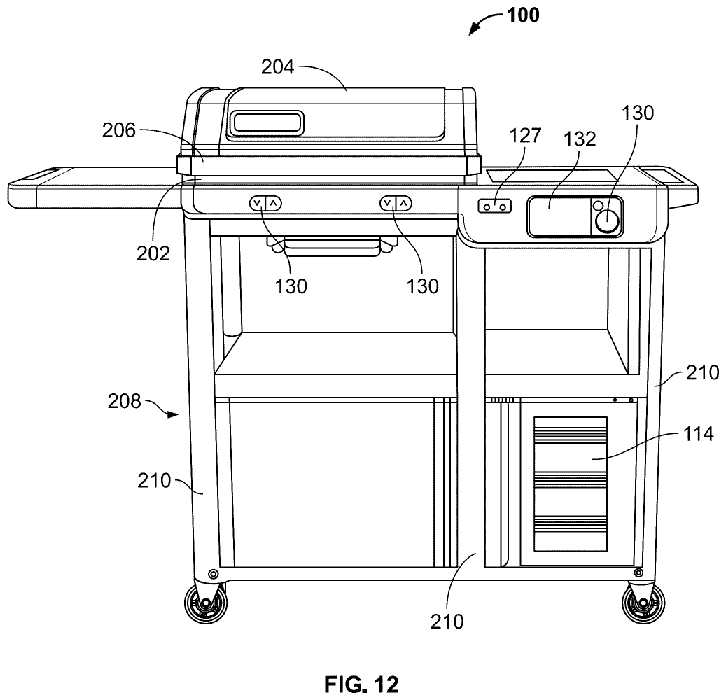

Embodiments of the electric grill 100 of FIG. I can be implemented with or without the air fryer 120. Thus, some embodiments of the electric grill 100 of FIG. 1 may include the air fryer 120, while other embodiments of the electric grill 100 of FIG. 1 may omit the air fryer 120. By way of example, the embodiment of the electric grill 100 illustrated in FIGS. 11 and 12 described herein includes the air fryer 120, while the embodiments of the electric grill 100 illustrated in FIGS. 2-10 described herein does not include the air fryer 120.

The temperature probe hub 127 of the electric grill 100 of FIG. 1 includes one or more probe jack(s), with each probe jack being configured to receive a connector (e.g., a plug) of a temperature probe such that the temperature probe is in electrical communication with the temperature probe hub 127. The temperature probe hub 127 is configured to receive data (e.g., temperature data) sensed, measured, and/or detected by any temperature probe hub that is in electrical communication with the temperature probe hub 127. In some examples, the temperature probe hub 127 receives data from one or more food probe(s), with each such food probe including a sensing portion (e.g., a sensing tip) that is configured to be inserted into an item of food (e.g., an item of food located within a cooking chamber of the electric grill 100) to sense, measure, and/or detect an internal temperature of the food item. In some examples, the temperature probe hub 127 receives data from one or more ambient probe(s), with each such ambient probe including a sensing portion (e.g., a sensing tip) that is configured to sense, measure, and/or detect an air temperature of a local area surrounding the ambient probe. Data, information, and/or signals sensed, measured, detected, and/or received by the temperature probe hub 127 of FIG. 1 can be of any quantity, type, form, and/or format. Data, information, and/or signals sensed, measured, detected, and/or received by the temperature probe hub 127 of FIG. 1 can be transmitted directly to the controller 138 of FIG. 1, and/or can be transmitted to and stored in the memory 140 of FIG. 1.

The user interface 128 of the electric grill 100 of FIG. 1 enables a user of the electric grill 100 to interact with the controller 138 of the electric grill 100. In the illustrated example of FIG. 1, the user interface 128 is operatively coupled to (e.g., in electrical communication with) the controller 138 and/or the memory 140 of the electric grill 100. In some examples, the user interface 128 is mechanically coupled to (e.g., fixedly connected to) the electric grill 100. For example, the user interface 128 can be mounted to a cookbox, a lid, a frame, or a side table of the electric grill 100. The user interface 128 is preferably mounted to a portion of the electric grill 100 that is readily accessible to a user of the electric grill 100, such as a front portion of a cookbox, a front portion of a lid, a front portion of a frame, or a front portion of a side table of the electric grill 100. In some examples, respective ones of the input device(s) 130 and/or the output device(s) 132 of the user interface 128 can be mounted to different portions of the electric grill 100. The architecture and/or operations of the user interface 128 can be distributed among any number of user interfaces respectively having any number of input device(s) 130 and/or output device(s) 132 located at and/or mounted to any portion of the electric grill 100.

The input device(s) 130 of the user interface 128 of FIG. 1 permit(s) the user of the electric grill 100 to enter data, information, selections, inputs, instructions, and/or commands into the controller 138. For example, the input device(s) 130 of the user interface 128 can permit the user of the electric grill 100 to enter data, information, one or more selection(s), one or more input(s), one or more instruction(s), and/or one or more command(s) into the controller 138 that cause(s) the controller 138 to implement (e.g., to initiate, to execute, and/or to terminate) one or more process(es) (e.g., one or more process(es) and/or protocol(s) configured to control one or more operation(s)) of the electric grill 100. The input device(s) 130 of the user interface 128 can be implemented, for example, by one or more of a touchscreen, a button, a dial, a knob, a switch, an audio sensor, a microphone, an image sensor, a camera, and/or a voice recognition system.

The output device(s) 132 of the user interface 128 of FIG. 1 facilitate(s) the presentation of data and/or information (e.g., data and/or information generated by the controller 138) to the user of the electric grill 100. For example, the output device(s) 132 of the user interface 128 can facilitate the presentation (e.g., textually, graphically, and/or audibly) of data and/or information (e.g., one or more notification(s), alert(s), and/or message(s)) associated with implementing (e.g., initiating, executing, and/or terminating) one or more process(es) (e.g., one or more process(es) and/or protocol(s) configured to control one or more operation(s)) of the electric grill 100. The output device(s) 132 of the user interface 128 can be implemented, for example, by one or more of a display device (e.g., a light emitting diode (LED), an organic light emitting diode (OLED), a liquid crystal display (LCD), a cathode ray tube (CRT) display, an in-plane switching (IPS) display, a touchscreen, etc.), a tactile output device, and/or a speaker.

The network interface 134 of the electric grill 100 of FIG. 1 enables a user of the electric grill 100 to remotely interact (e.g., via one or more of the remote device(s) 146) with the electric grill 100. In the illustrated example of FIG. 1, the network interface 134 is operatively coupled to (e.g., in electrical communication with) the controller 138 and/or the memory 140 of the electric grill 100. The network interface 134 of FIG. 1 includes one or more communication device(s) 136 (e.g., transmitter(s), receiver(s), transceiver(s), modem(s), gateway(s), wireless access point(s), etc.) to facilitate the exchange of data with external machines (e.g., computing devices of any kind, including the remote device(s) 146 of FIG. 1) by a wired or wireless communication network. Communications transmitted and/or received via the communication device(s) 136 and/or, more generally, via the network interface 134 can be made over and/or carried by, for example, an Ethernet connection, a digital subscriber line (DSL) connection, a telephone line connection, a coaxial cable system, a satellite system, a wireless system, a cellular telephone system, an optical connection, etc.

The controller 138 of the electric grill 100 of FIG. 1 implements processor circuitry to control and/or manage one or more operation(s) associated with the electric grill 100 of FIG. 1 and/or the components thereof, including the first heating element 104, the second heating element 106, the first convection fan 108, the second convection fan 110, and/or the temperature sensor 112 of the cooking chamber 102 of FIG. 1, the heating element 116 and/or the temperature sensor 118 of the warming cabinet 114 of FIG. 1, the heating element 122, the convection fan 124, and/or the temperature sensor 126 of the air fryer 120 of FIG. 1, and/or the temperature probe hub 127, the user interface 128 (e.g., including the input device(s) 130 and the output device(s) 132), the network interface 134 (e.g., including the communication device(s) 136), the controller 138, the memory 140, and/or the power supply 142 of the electric grill 100 of FIG. 1. The processor circuitry of the controller 138 of FIG. 1 includes any type(s) and/or any number(s) of processor(s), microprocessor(s), controller(s), microcontroller(s), ASIC(s), PLD(s), FPLD(s), FPGA(s), DSP(s), GPU(s), CPU(s), semiconductor-based (e.g., silicon-based) circuit(s), digital circuit(s), analog circuit(s), logic circuit(s), and/or integrated circuit(s) implemented by any type(s) and/or any number(s) of transistor(s), capacitor(s), diode(s), inductor(s), resistor(s), timer(s), counter(s), printed circuit board(s), connector(s), wire(s), and/or other electrical circuit component(s).

In the illustrated example of FIG. 1, the controller 138 is graphically represented as a single, discrete structure that manages and/or controls the operation(s) of various components of the electric grill 100. It is to be understood, however, that in other examples, the architecture and/or operations of the controller 138 can be distributed among any number of controllers, with each separate controller having a dedicated subset of one or more operation(s) described herein. In some examples, the electric grill 100 can include separate, distinct controllers for one or more of the first heating element 104, the second heating element 106, the first convection fan 108, the second convection fan 110, and/or the temperature sensor 112 of the cooking chamber 102 of FIG. 1, the heating element 116 and/or the temperature sensor 118 of the warming cabinet 114 of FIG. 1, the heating element 122, the convection fan 124, and/or the temperature sensor 126 of the air fryer 120 of FIG. 1, and/or the temperature probe hub 127, the user interface 128 (e.g., including the input device(s) 130 and the output device(s) 132), the network interface 134 (e.g., including the communication device(s) 136), the controller 138, the memory 140, and/or the power supply 142 of the electric grill 100 of FIG. 1.

In the illustrated example of FIG. 1, the controller 138 is operatively coupled to (e.g., in electrical communication with) one or more of the first heating element 104, the second heating element 106, the first convection fan 108, the second convection fan 110, and/or the temperature sensor 112 of the cooking chamber 102 of FIG. 1, the heating element 116 and/or the temperature sensor 118 of the warming cabinet 114 of FIG. 1, the heating element 122, the convection fan 124, and/or the temperature sensor 126 of the air fryer 120 of FIG. 1, and/or the temperature probe hub 127, the user interface 128 (e.g., including the input device(s) 130 and the output device(s) 132), the network interface 134 (e.g., including the communication device(s) 136), the memory 140, and/or the power supply 142 of the electric grill 100 of FIG. 1. The controller 138 of FIG. 1 is also operatively coupled to (e.g., in wired or wireless electrical communication with) the remote device(s) 146 of FIG. 1 via the network interface 134 (e.g., including the communication device(s) 136) of the electric grill 100 of FIG. 1.

The controller 138 of FIG. 1 is configured to receive commands, instructions, signals, and/or data from, and/or to transmit commands, instructions, signals, and/or data to, the first heating element 104, the second heating element 106, the first convection fan 108, the second convection fan 110, and/or the temperature sensor 112 of the cooking chamber 102 of FIG. 1, the heating element 116 and/or the temperature sensor 118 of the warming cabinet 114 of FIG. 1, the heating element 122, the convection fan 124, and/or the temperature sensor 126 of the air fryer 120 of FIG. 1, the temperature probe hub 127, the user interface 128 (e.g., including the input device(s) 130 and the output device(s) 132), the network interface 134 (e.g., including the communication device(s) 136), the memory 140, and/or the power supply 142 of the electric grill 100 of FIG. 1 in connection with implementing (e.g., initiating, executing, and/or terminating) one or more protocol(s), process(es), program(s), sequence(s), subroutine(s), and/or method(s), as further described herein.

The controller 138 of FIG. 1 is configured to independently control the first heating element 104, the second heating element 106, the first convection fan 108, and/or the second convection fan 110 of the cooking chamber 102 of FIG. 1. For example, the controller 138 can command, instruct, and/or signal the second heating element 106 of the cooking chamber 102 to operate in a manner that is independent (e.g., by way of timing, heat intensity, etc.) of the controller 138 separately commanding, instructing, and/or signaling the first heating element 104 of the cooking chamber 102 to operate. As another example, the controller 138 can command, instruct, and/or signal the second convection fan 110 of the cooking chamber 102 to operate in a manner that is independent (e.g., by way of timing, fan speed, etc.) of the controller 138 separately commanding, instructing, and/or signaling the first convection fan 108 of the cooking chamber 102 to operate. Furthermore, the controller 138 can command, instruct, and/or signal either convection fan (e.g., the first convection fan 108 or the second convection fan 110) of the cooking chamber 102 to operate in a manner that is independent (e.g., by way of timing, function, etc.) of the controller 138 separately commanding, instruction, and/or signaling either heating element (e.g., the first heating element 104 or the second heating element 106) of the cooking chamber 102 to operate.

In some examples, the controller 138 of FIG. 1 may command, instruct, and/or signal two or more of the first heating element 104, the second heating element 106, the first convection fan 108, and/or the second convection fan 110 of the cooking chamber 102 to operate concurrently (e.g., at the same time, or at overlapping time intervals). For example, the controller 138 may command, instruct, and/or signal the first heating element 104 and the second heating element 106 of the cooking chamber 102 to operate concurrently. As another example, the controller 138 may command, instruct, and/or signal the first convection fan 108 and the second convection fan 110 of the cooking chamber 102 to operate concurrently. As another example, the controller 138 may command, instruct, and/or signal the first heating element 104 and the first convection fan 108 of the cooking chamber 102 to operate concurrently, and/or may separately command, instruct, and/or signal the second heating element 106 and the second convection fan 110 of the cooking chamber 102 to operate concurrently. As yet another example, the controller 138 may command, instruct, and/or signal the first heating element 104, the second heating element 106, the first convection fan 108, and the second convection fan 110 of cooking chamber 102 to operate concurrently. In some such examples, the controller 138 of FIG. 1 maintains independent control over each one of the concurrently-operated components of the cooking chamber 102 despite the fact that such components are operating at the same time.

In addition to independently controlling the first heating element 104, the second heating element 106, the first convection fan 108, and the second convection fan 110 of the cooking chamber 102 of FIG. 1, the controller 138 of FIG. 1 is further configured to independently control the heating element 116 of the warming cabinet 114 of FIG. 1. For example, the controller 138 can command, instruct, and/or signal the heating element 116 of the warming cabinet 114 to operate in a manner that is independent (e.g., by way of timing, heat intensity, etc.) of the controller 138 separately commanding, instructing, and/or signaling either heating element (e.g., the first heating element 104 or the second heating element 106) of the cooking chamber 102 to operate. In some examples, the controller 138 of FIG. 1 may command, instruct, and/or signal the heating element 116 of the warming cabinet 114 to operate concurrently (e.g., at the same time, or at overlapping time intervals) with one or more component(s) of the cooking chamber 102. For example, the controller 138 may command, instruct, and/or signal the heating element 116 of the warming cabinet 114 to operate concurrently with the first heating element 104 and/or the second heating element 106 of the cooking chamber 102. In some such examples, the controller 138 of FIG. 1 maintains independent control over each one of the concurrently-operated components of the cooking chamber 102 and the warming cabinet 114 despite the fact that such components are operating at the same time.

In addition to independently controlling the first heating element 104, the second heating element 106, the first convection fan 108, and the second convection fan 110 of the cooking chamber 102 of FIG. 1, the controller 138 of FIG. 1 is further configured to independently control the heating clement 122 and the convection fan 124 of the air fryer 120 of FIG. 1. For example, the controller 138 can command, instruct, and/or signal the heating element 122 of the air fryer 120 to operate in a manner that is independent (e.g., by way of timing, heat intensity, etc.) of the controller 138 separately commanding, instructing, and/or signaling either heating element (e.g., the first heating element 104 or the second heating element 106) of the cooking chamber 102 to operate. As another example, the controller 138 can command, instruct, and/or signal the convection fan 124 of the air fryer 120 to operate in a manner that is independent (e.g., by way of timing, fan speed, etc.) of the controller 138 separately commanding, instructing, and/or signaling either convection fan (e.g., the first convection fan 108 or the second convection fan 110) of the cooking chamber 102 to operate.

In some examples, the controller 138 of FIG. 1 may command, instruct, and/or signal the heating element 122 and/or the convection fan 124 of the air fryer 120 to operate concurrently (e.g., at the same time, or at overlapping time intervals) with one or more component(s) of the cooking chamber 102. For example, the controller 138 may command, instruct, and/or signal the heating element 122 of the air fryer 120 to operate concurrently with the first heating element 104 and/or with the second heating element 106 of the cooking chamber 102. As another example, the controller 138 may command, instruct, and/or signal the convection fan 124 of the air fryer 120 to operate concurrently with the first convection fan 108 and/or the second convection fan 110 of the cooking chamber 102. In some such examples, the controller 138 of FIG. 1 maintains independent control over each one of the concurrently-operated components of the cooking chamber 102 and the air fryer 120 despite the fact that such components are operating at the same time.

In some examples, the controller 138 of FIG. 1 controls, manages, executes, and/or performs one or more process(es), protocol(s), and/or program(s) associated with one or more operation(s) of the electric grill 100. In some such process(es), protocol(s), and/or program(s), the controller 138 of FIG. 1 determines whether one or more control input(s) associated with one or more operation(s) of the electric grill 100 of FIG. 1 has/have been received. For example, the controller 138 can determine whether the user interface 128 and/or the network interface 134 of the electric grill 100 of FIG. 1 has/have received any commands, instructions, signals, inputs, and/or other data indicative of a control input associated with an operation of the electric grill 100 (e.g., a desired ON/OFF state, a desired temperature, a desired fan speed, a desired cooking, warming, or air frying mode, a desired cooking, warming, or air frying recipe, a desired cooking, warming, or air frying program, and/or any other state, setting, selection, mode, or program pertaining to an operation of the electric grill 100).

If the controller 138 of FIG. 1 determines that one or more control input(s) associated with one or more operation(s) of the electric grill 100 has/have been received, the controller 138 subsequently determines whether any of the received control input(s) is/are associated with an operation of the cooking chamber 102 of the electric grill 100. For example, the controller 138 can determine whether any of the received control input(s) is/are associated with one or more operation(s) of the first heating element 104, the second heating element 106, the first convection fan 108, and/or the second convection fan 110 of the cooking chamber 102 of the electric grill 100 (e.g., a desired ON/OFF state, a desired temperature, a desired fan speed, a desired cooking mode, a desired cooking recipe, a desired cooking program, and/or any other state, setting, selection, mode, or program pertaining to an operation of the first heating element 104, the second heating element 106, the first convection fan 108, and/or the second convection fan 110 of the cooking chamber 102 of the electric grill 100).

If the controller 138 of FIG. 1 determines that one or more of the received control input(s) is/are associated with one or more operation(s) of the cooking chamber 102 of the electric grill 100, the controller 138 commands, instructs, signals, and/or otherwise causes one or more of the heating clement(s) (e.g., the first heating element 104 and/or the second heating element 106) and/or one or more of the convection fan(s) (e.g., the first convection fan 108 and/or the second convection fan 110) of the cooking chamber 102 of FIG. 1 to operate in a manner that corresponds to, achieves, and/or otherwise implements respective ones of the received control input(s) which the controller 138 determined to be associated with the operation(s) of the cooking chamber 102 of the electric grill 100. In some examples, the controller 138 independently controls the first heating element 104, the second heating element 106, the first convection fan 108, and/or the second convection fan 110 of the cooking chamber 102, as discussed above. In some examples, the controller 138 considers and/or utilizes temperature data obtained from the temperature sensor 112 of the cooking chamber 102 as an input to a control loop (e.g., a feedback input to a PID control loop) implemented by the controller 138 in connection with controlling the first heating element 104, the second heating element 106, the first convection fan 108, and/or the second convection fan 110 of the cooking chamber 102.

In embodiments in which the electric grill 100 includes the warming cabinet 114 in addition to the cooking chamber 102, the controller 138 of FIG. 1 additionally determines whether any of the received control input(s) is/are associated with an operation of the warming cabinet 114 of the electric grill 100. For example, the controller 138 can determine whether any of the received control input(s) is/are associated with one or more operation(s) of the heating element 116 of the warming cabinet 114 of the electric grill 100 (e.g., a desired ON/OFF state, a desired temperature, a desired warming mode, a desired warming recipe, a desired warming program, and/or any other state, setting, selection, mode, or program pertaining to an operation of the heating element 116 of the warming cabinet 114 of the electric grill 100).

If the controller 138 of FIG. 1 determines that one or more of the received control input(s) is/are associated with one or more operation(s) of the warming cabinet 114 of the electric grill 100, the controller 138 commands, instructs, signals, and/or otherwise causes the heating element 116 of the warming cabinet 114 of FIG. 1 to operate in a manner that corresponds to, achieves, and/or otherwise implements respective ones of the received control input(s) which the controller 138 determined to be associated with the operation(s) of the warming cabinet 114 of the electric grill 100. In some examples, the controller 138 independently controls the heating element 116 of the warming cabinet 114, as discussed above. In some examples, the controller 138 considers and/or utilizes temperature data obtained from the temperature sensor 118 of the warming cabinet 114 as an input to a control loop (e.g., a feedback input to a PID control loop) implemented by the controller 138 in connection with controlling the heating element 116 of the warming cabinet 114.

In embodiments in which the electric grill 100 includes the air fryer 120 in addition to the cooking chamber 102, the controller 138 of FIG. 1 additionally determines whether any of the received control input(s) is/are associated with an operation of the air fryer 120 of the electric grill 100. For example, the controller 138 can determine whether any of the received control input(s) is/are associated with one or more operation(s) of the heating element 122 and/or the convection fan 124 of the electric grill 100 (e.g., a desired ON/OFF state, a desired temperature, a desired fan speed, a desired air frying mode, a desired air frying recipe, a desired air frying program, and/or any other state, setting, selection, mode, or program pertaining to an operation of the heating element 122 and/or the convection fan 124 of the air fryer 120 of the electric grill 100).

If the controller 138 of FIG. 1 determines that one or more of the received control input(s) is/are associated with one or more operation(s) of the air fryer 120 of the electric grill 100, the controller 138 commands, instructs, signals, and/or otherwise causes the heating element 122 and/or the convection fan 124 of the air fryer 120 of FIG. 1 to operate in a manner that corresponds to, achieves, and/or otherwise implements respective ones of the received control input(s) which the controller 138 determined to be associated with the operation(s) of the air fryer 120 of the electric grill 100. In some examples, the controller 138 independently controls the heating element 122 and/or the convection fan 124 of the air fryer 120, as discussed above. In some examples, the controller 138 considers and/or utilizes temperature data obtained from the temperature sensor 126 of the air fryer 120 as an input to a control loop (e.g., a feedback input to a PID control loop) implemented by the controller 138 in connection with controlling the heating element 122 and/or the convection fan 124 of the air fryer 120.

In some examples, the controller 138 of FIG. 1 additionally determines whether to continue operating the electric grill 100. For example, the controller 138 can determine whether the user interface 128 and/or the network interface 134 of the electric grill 100 of FIG. 1 has/have received any commands, instructions, signals, inputs, and/or other data indicative of a request to terminate one or more operation(s) of the electric grill 100 and/or, more generally, to cease operating the electric grill 100. If the controller 138 determines that one or more operation(s) of the electric grill are to cease, the controller 138 causes such operation(s) to cease.

The memory 140 of the electric grill 100 of FIG. 1 can be implemented by any type(s) and/or any number(s) of storage device(s) such as an optical storage device, a magnetic storage device, a floppy disk drive, a hard disk drive (HDD), a solid state storage device, a flash memory, a read-only memory (ROM), a random-access memory (RAM), a volatile memory, a non-volatile memory, a cache, a CD, a DVD, a Blu-ray disk, and/or any other tangible storage device or tangible storage disk in which information is stored for any duration (e.g., permanently, for extended time periods, for brief instances, for temporarily buffering, and/or for caching of the information). The information and/or data stored in the memory 140 of FIG. I can be stored in any file and/or data structure format, organization scheme, and/or arrangement. The memory 140 of FIG. 1 is accessible to one or more of the first heating element 104, the second heating element 106, the first convection fan 108, the second convection fan 110, and/or the temperature sensor 112 of the cooking chamber 102 of FIG. 1, the heating element 116 and/or the temperature sensor 118 of the warming cabinet 114 of FIG. 1, the heating element 122, the convection fan 124, and/or the temperature sensor 126 of the air fryer 120 of FIG. 1, and/or the temperature probe hub 127, the user interface 128 (e.g., including the input device(s) 130 and the output device(s) 132), the network interface 134 (e.g., including the communication device(s) 136), the controller 138, and/or the power supply 142 of the electric grill 100 of FIG. 1.

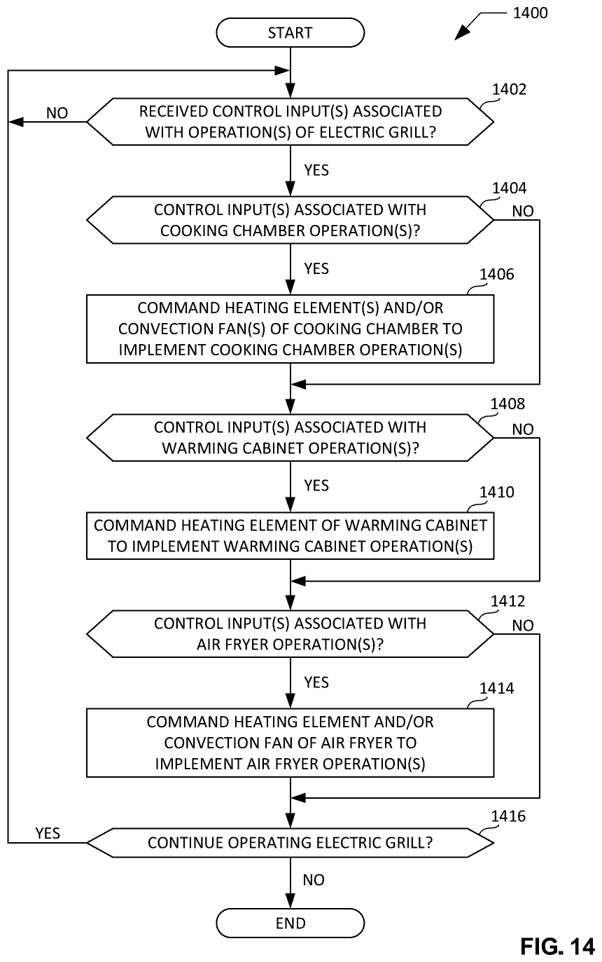

The memory 140 of the electric grill 100 of FIG. 1 stores data sensed, measured, detected, generated, determined, computed, calculated, identified, presented, input, output, transmitted, and/or received by, to, and/or from the first heating element 104, the second heating element 106, the first convection fan 108, the second convection fan 110, and/or the temperature sensor 112 of the cooking chamber 102 of FIG. 1, the heating element 116 and/or the temperature sensor 118 of the warming cabinet 114 of FIG. 1, the heating element 122, the convection fan 124, and/or the temperature sensor 126 of the air fryer 120 of FIG. 1, and/or the temperature probe hub 127, the user interface 128 (e.g., including the input device(s) 130 and the output device(s) 132), the network interface 134 (e.g., including the communication device(s) 136), the controller 138, and/or the power supply 142 of the electric grill 100 of FIG. 1. The memory 140 also stores instructions (e.g., computer-readable instructions) and associated data corresponding to one or more protocol(s), process(es), program(s), sequence(s), subroutine(s), and/or method(s) described below in connection with FIG. 14. The memory 140 can also store correlation data, threshold data, and/or settings data associated with such protocol(s), process(es), program(s), sequence(s), subroutine(s), and/or method(s).

The power supply 142 of the electric grill 100 of FIG. 1 is configured to receive AC power from an example AC line power source 144 (e.g., a wall outlet) to which the power supply 142 of the electric grill 100 is electrically connected. The power supply 142 converts AC power received from the AC line power source 144 into DC power that can thereafter be supplied to one or more electrically-powered component(s) of the electric grill 100 of FIG. 1, including any electrically-powered component of the cooking chamber 102 (e.g., the first heating element 104, the second heating element 106, the first convection fan 108, the second convection fan 110, and/or the temperature sensor 112 of the cooking chamber 102), any electrically-powered component of the warming cabinet 114 (e.g., the heating element 116 and/or the temperature sensor 118 of the warming cabinet 114), any electrically-powered component of the air fryer 120 (e.g., the heating element 122, the convection fan 124, and/or the temperature sensor 126 of the air fryer 120), the temperature probe hub 127, the user interface 128 (e.g., including the input device(s) 130 and/or the output device(s) 132), the network interface 134 (e.g., including the communication device(s) 136), the controller 138, and/or the memory 140 of the electric grill 100. In some examples, the distribution of DC power from the power supply 142 to any of the aforementioned electrically-powered components of the electric grill 100 can be controlled and/or managed by the user interface 128 and/or the controller 138. In other examples, the power supply 142 of FIG. 1 can alternatively be implemented by a battery (or a plurality of batteries) dedicated to powering one or more of the aforementioned electrically-powered component(s) of the electric grill 100.

The remote device(s) 146 of FIG. 1 can be implemented by any type(s) and/or any number(s) of mobile or stationary computing devices. In this regard, examples of such remote device(s) 146 include a smartphone, a tablet, a laptop, a desktop, a cloud server, a wearable computing device, a wireless control hub, etc. The remote device(s) 146 of FIG. 1 facilitate(s) a remote (e.g., wired, or wireless) extension of the above-described user interface 128 of the electric grill 100. In this regard, each remote device 146 includes one or more input device(s) and/or one or more output device(s) that mimic and/or enable a remotely-located version of the above-described functionality of the corresponding input device(s) 130 and/or the corresponding output device(s) 132 of the user interface 128 of the electric grill 100. Accordingly, one or more input(s), selection(s), instruction(s), and/or command(s) received at the electric grill 100 (e.g., via the communication device(s) 136 of the network interface 134 of the electric grill 100) from the remote device(s) 146 can be entered and/or made via the input device(s) of the remote device(s) 146 much in the same way that such input(s), selection(s), instruction(s), and/or command(s) would be entered and/or made via the input device(s) 130 of the user interface 128 of the electric grill 100. Similarly, one or more notification(s), prompt(s), request(s), and/or confirmation(s) transmitted from the electric grill 100 (e.g., via the communication device(s) 136 of the network interface 134 of the electric grill 100) to the remote device(s) 146 can be presented via the output device(s) of the remote device(s) 146 much in the same way that such notification(s), prompt(s), request(s), and/or confirmation(s) would be presented via the output device(s) 132 of the user interface 128 of the electric grill 100.

While an example manner of implementing the electric grill 100 is illustrated in FIG. 1, one or more of the elements, processes, and/or devices illustrated in FIG. 1 may be combined, divided, re-arranged, omitted, eliminated, and/or implemented in any other way. Further, the first heating element 104, the second heating element 106, the first convection fan 108, the second convection fan 110, and/or the temperature sensor 112 of the cooking chamber 102 of FIG. 1, the heating element 116 and/or the temperature sensor 118 of the warming cabinet 114 of FIG. 1, the heating element 122, the convection fan 124, and/or the temperature sensor 126 of the air fryer 120 of FIG. 1, the temperature probe hub 127, the user interface 128 (e.g., including the input device(s) 130 and the output device(s) 132), the network interface 134 (e.g., including the communication device(s) 136), the controller 138, the memory 140, the power supply 142, and/or, more generally, the electric grill 100 of FIG. 1, may be implemented by hardware alone or by hardware in combination with software and/or firmware. Thus, for example, any of the first heating element 104, the second heating element 106, the first convection fan 108, the second convection fan 110, and/or the temperature sensor 112 of the cooking chamber 102 of FIG. 1, the heating element 116 and/or the temperature sensor 118 of the warming cabinet 114 of FIG. 1, the heating element 122, the convection fan 124, and/or the temperature sensor 126 of the air fryer 120 of FIG. 1, the temperature probe hub 127, the user interface 128 (e.g., including the input device(s) 130 and the output device(s) 132), the network interface 134 (e.g., including the communication device(s) 136), the controller 138, the memory 140, the power supply 142, and/or, more generally, the electric grill 100 of FIG. 1 could be implemented at least in part by processor circuitry including any type(s) and/or any number(s) of processor(s), microprocessor(s), controller(s), microcontroller(s), ASIC(s), PLD(s), FPLD(s), FPGA(s), DSP(s), GPU(s), CPU(s), semiconductor-based (e.g., silicon-based) circuit(s), digital circuit(s), analog circuit(s), logic circuit(s), and/or integrated circuit(s) implemented by any type(s) and/or any number(s) of transistor(s), capacitor(s), diode(s), inductor(s), resistor(s), timer(s), counter(s), printed circuit board(s), connector(s), wire(s), and/or other electrical circuit component(s).

Further still, the electric grill 100 of FIG. 1 may include one or more element(s), component(s), and/or device(s) in addition to, or instead of, those illustrated in FIG. 1, and/or may include more than one of any or all of the illustrated element(s), component(s), and/or device(s). For example, the cooking chamber 102, the warming cabinet 114, and/or the air fryer 120 of the electric grill 100 of FIG. 1 can respectively include any types(s) and/or any number(s) of heating elements, fans, and/or sensors, either in addition to, or instead of, those illustrated in FIG. 1. As one such example, the cooking chamber 102 of FIG. 1 can include a third heating element and a third convection fan in addition to the first heating element 104, the second heating element 106, the first convection fan 108, and the second convection fan 110 of the cooking chamber 102 illustrated in FIG. 1.

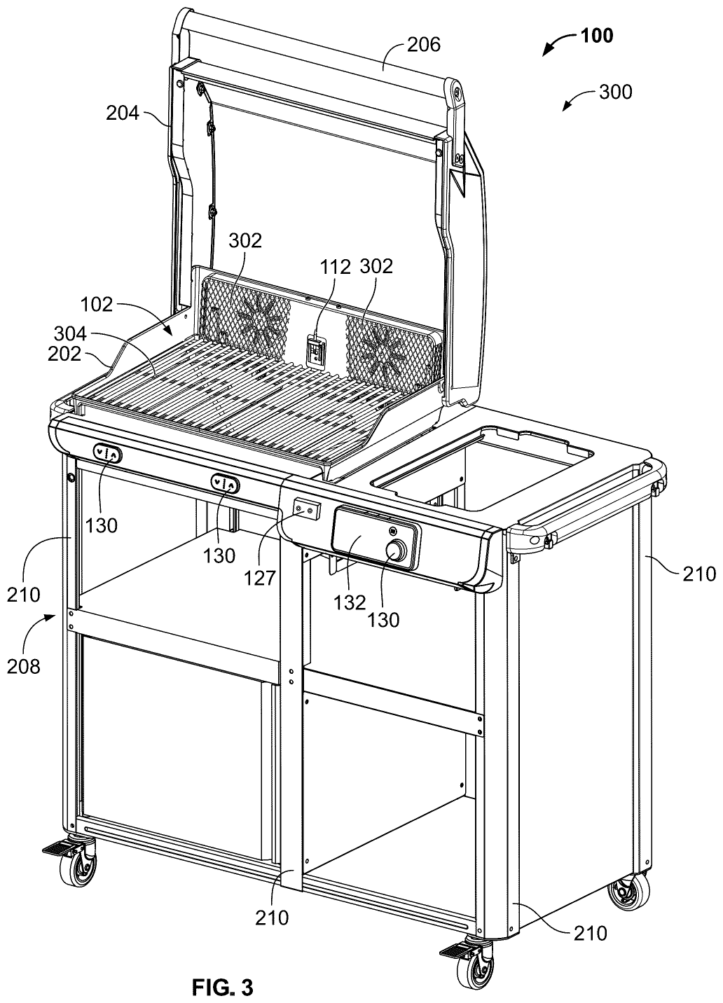

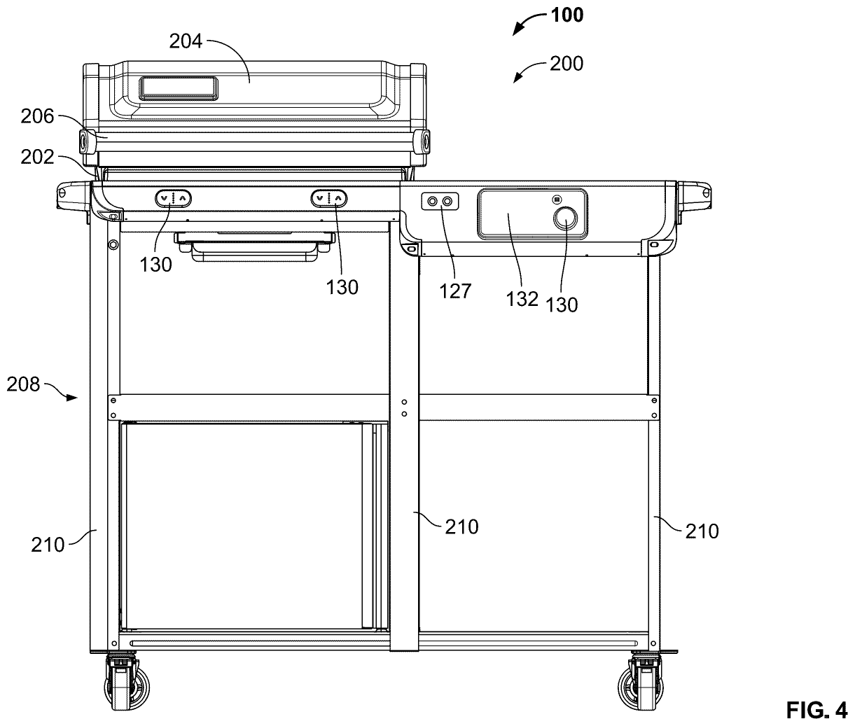

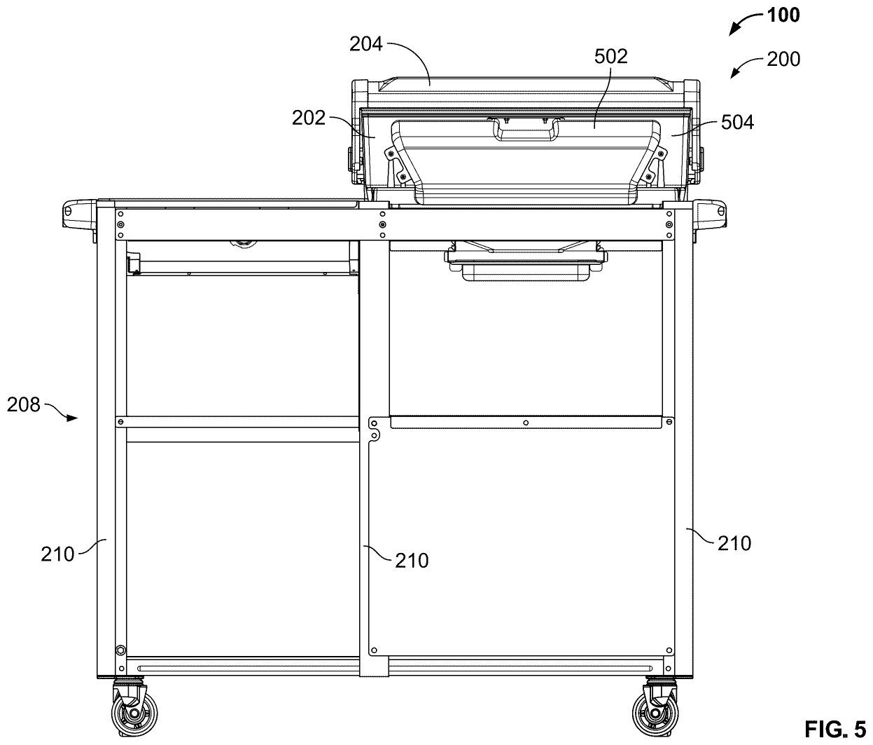

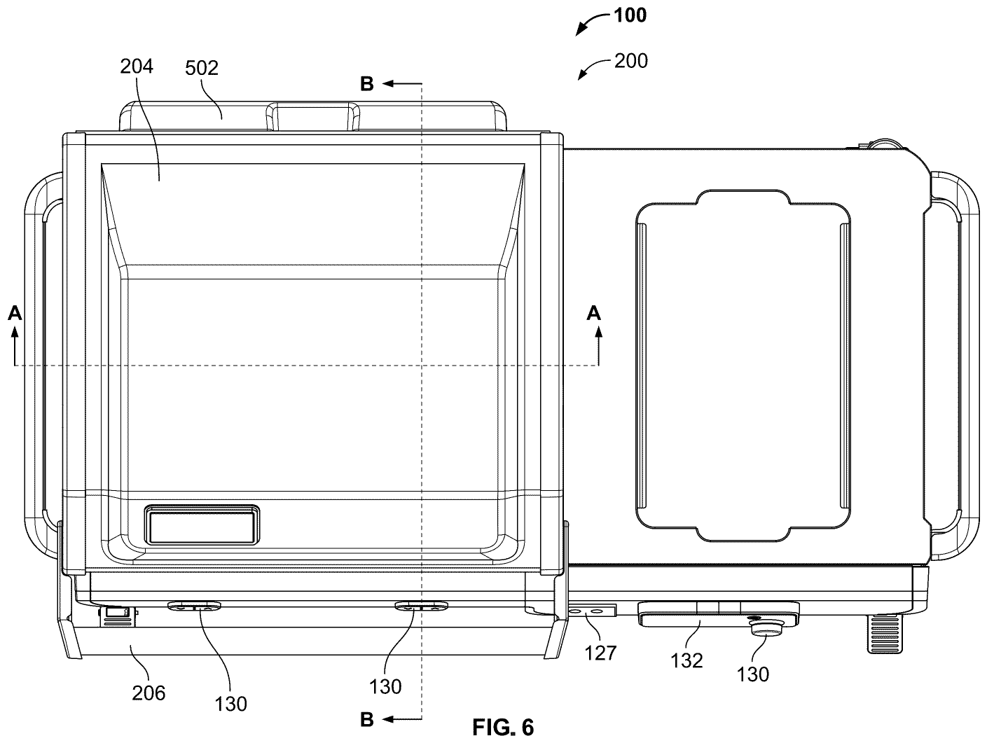

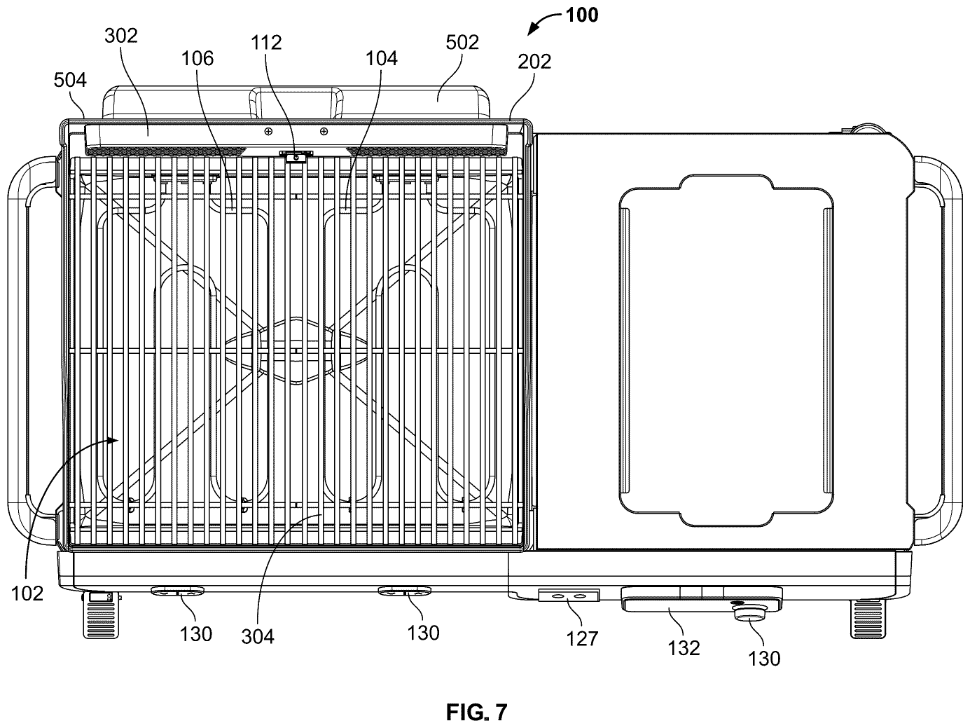

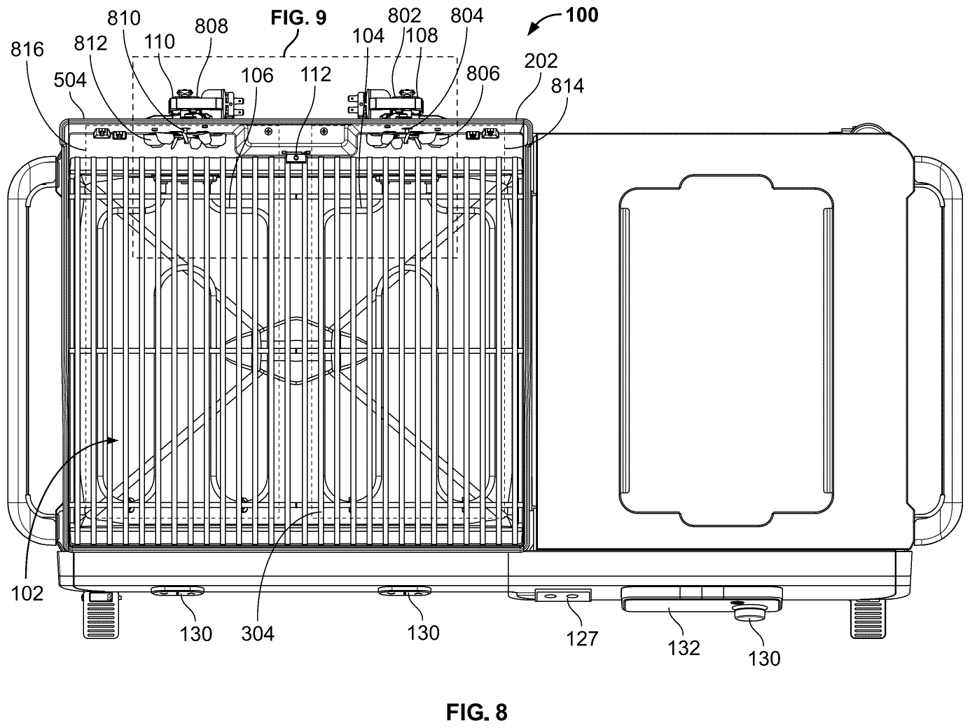

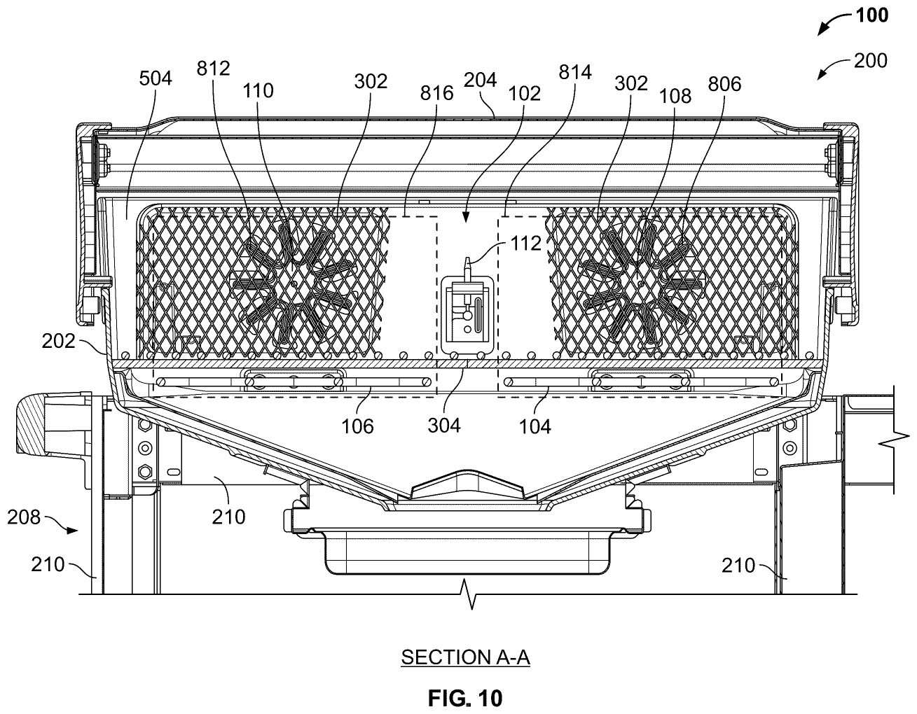

FIG. 2 is a perspective view of an example first implementation of the electric grill 100 of FIG. 1, with an example lid 204 of the electric grill 100 shown in an example closed position 200 relative to an example cookbox 202 of the electric grill 100. FIG. 3 is a perspective view of the electric grill 100 as shown in FIG. 2, with the lid 204 of the electric grill 100 shown in an example open position 300 relative to the cookbox 202 of the electric grill 100. FIG. 4 is a front view of the electric grill 100 as shown in FIG. 2. FIG. 5 is a rear view of the electric grill 100 as shown in FIGS. 2 and 4. FIG. 6 is a top view of the electric grill 100 as shown in FIGS. 2, 4, and 5. FIG. 7 is a top view of the electric grill 100 as shown in FIGS. 2 and 4-6, with the lid 204 of the electric grill 100 omitted. FIG. 8 is a top view of the electric grill 100 as shown in FIGS. 2 and 4-6, with the lid 204, an example interior fan guard 302, and an example exterior fan guard 502 of the electric grill 100 omitted. FIG. 9 is an enlarged view of a portion of FIG. 8. FIG. 10 is a cross-sectional view of the electric grill 100 as shown in FIGS. 2 and 4-6, taken along section A-A of FIG. 6. FIG. 11 is a cross-sectional view of the electric grill 100 as shown in FIGS. 2 and 4-6, taken along section B-B of FIG. 6. In the illustrated example of FIGS. 2-11, the electric grill 100 includes the cooking chamber 102 of FIG. 1 described above, but lacks both the warming cabinet 114 and the air fryer 120 of FIG. 1 described above.

As shown in FIGS. 2-6, 10, and 11, the lid 204 of the electric grill 100 is configured to cover and/or enclose the cookbox 202 when the lid 204 is in the closed position 200. The lid 204 is movably (e.g., pivotally) coupled to the cookbox 202 such that the lid 204 can be moved (e.g., pivoted) relative to the cookbox 202 between the closed position 200 (e.g., as shown in FIG. 2) and the open position 300 (e.g., as shown in FIG. 3). Movement of the lid 204 between the closed position 200 and the open position 300 can be facilitated via user interaction with an example handle 206 of the electric grill 100 that is coupled to the lid 204. In the illustrated example of FIGS. 2-6, 10 and 11, the cookbox 202 and the lid 204 collectively define the cooking chamber 102 of the electric grill 100, with the cooking chamber 102 being configured to cook (e.g., grill) one or more item(s) of food located therein. The cooking chamber 102 becomes accessible to a user of the electric grill 100 when the lid 204 is moved from the closed position 200 toward and/or into the open position 300. Conversely, the cooking chamber 102 is generally inaccessible to the user of the electric grill 100 when the lid 204 is in the closed position 200.

As shown in FIGS. 3 and 7-11, the electric grill 100 of FIGS. 2-11 includes an example cooking grate 304 located within the cooking chamber 102 of the electric grill 100. The cooking grate 304 is configured to support one or more item(s) of food within the cooking chamber 102. As shown in FIGS. 3 and 7-11, the cooking grate 304 is supported and/or carried by the cookbox 202 of the electric grill 100. User access to the cooking grate 304 and/or the cooking chamber 102 of the electric grill 100 may periodically become necessary, for example, to add an item of food to the cooking chamber 102 (e.g., at or toward the beginning of a cook), to remove an item of food from the cooking chamber 102 (e.g., at or toward the end of a cook), and/or to flip, rotate, relocate, or otherwise move an item of food within the cooking chamber 102 (e.g., during the middle of a cook).

As further shown in FIGS. 3 and 7-11, the first heating element 104, the second heating element 106, the first convection fan 108, and the second convection fan 110 of the electric grill 100 are located at least partially within the cooking chamber 102 of the electric grill 100, with the first heating element 104, the second heating element 106, the first convection fan 108, and/or the second convection fan 110 being supported and/or carried by the cookbox 202 of the electric grill 100. The first convection fan 108 of the electric grill 100 is coupled and/or mounted to an example rear wall 504 of the cookbox 202 of the electric grill 100. The first convection fan 108 includes an example electric motor 802, an example rotatable shaft 804 operatively coupled to the electric motor 802, and a plurality of example blades 806 operatively coupled to the rotatable shaft 804. The blades 806 of the first convection fan 108 are located within the cooking chamber 102. The electric motor 802 of the first convection fan 108 is located at least partially outside of (e.g., external to) the cooking chamber 102. The rotatable shaft 804 of the first convection fan 108 extends through the rear wall 504 of the cookbox 202 of the electric grill 100.

The second convection fan 110 of the electric grill 100 is structured and/or configured in a manner that is substantially similar to the first convection fan 108. In this regard, the second convection fan 110 is coupled and/or mounted to the rear wall 504 of the cookbox 202 of the electric grill 100. The second convection fan 110 includes an example electric motor 808, an example rotatable shaft 810 operatively coupled to the electric motor 808, and a plurality of example blades 812 operatively coupled to the rotatable shaft 810. The blades 812 of the second convection fan 110 are located within the cooking chamber 102. The electric motor 808 of the second convection fan 110 is located at least partially outside of (e.g., external to) the cooking chamber 102. The rotatable shaft 810 of the second convection fan 110 extends through the rear wall 504 of the cookbox 202 of the electric grill 100.

As shown in FIGS. 7-11, the first heating element 104 and the second heating element 106 of the electric grill 100 of FIGS. 2-11 are located within the cooking chamber 102 below the cooking grate 304, with the second heating element 106 being laterally offset from (e.g., located to the left of) the first heating element 104. The cooking grate 304, the first heating element 104, and the second heating element 106 are oriented substantially horizontally within the cooking chamber 102. The first convection fan 108 and the second convection fan 110 of the electric grill 100 of FIGS. 2-11 are located within the cooking chamber 102 above the cooking grate 304, with the second convection fan 110 being laterally offset from (e.g., located to the left of) the first convection fan 108. The first convection fan 108 and the second convection fan 110 are oriented substantially vertically within the cooking chamber 102.

As shown in FIGS. 8-11, the first convection fan 108 is laterally aligned with the first heating element 104 within the cooking chamber 102, and the second convection fan 110 is laterally aligned with the second heating element 106 within the cooking chamber 102. As further shown in FIGS. 8-11, the first heating element 104 and the first convection fan 108 of the electric grill 100 of FIGS. 2-11 provide an example first controllable cooking zone 814 within the cooking chamber 102, and the second heating element 106 and the second convection fan 110 of the electric grill of FIGS. 2-11 provide an example second controllable cooking zone 816 within the cooking chamber 102, with the second controllable cooking zone 816 being laterally offset from (e.g., located to the left of) the first controllable cooking zone 814. The temperature sensor 112 of the cooking chamber 102 is coupled to the rear wall 504 of the cookbox 202, with the temperature sensor 112 being located between the first heating element 104 and the second heating element 106, between the first convection fan 108 and the second convection fan 110, and/or between the first controllable cooking zone 814 and the second controllable cooking zone 816.

As shown in FIGS. 3, 5-7, 10, and 11, one or more portion(s) of the first convection fan 108 and/or the second convection fan 110 of the cooking chamber 102 is/are covered and/or protected by one or more guard(s). For example, as shown in FIGS. 3, 7, 10, and 11, an example interior fan guard 302 located within the cooking chamber 102 covers and/or protects the blades 806 of the first convection fan 108 and/or the blades 812 of the second convection fan 110. In the illustrated example, the interior fan guard 302 is configured as a cage including a gridded, latticed, and/or meshed framework having a plurality of openings extending therethrough. The interior fan guard 302 is accordingly configured to enable a flow of air from the first convection fan 108 and/or a flow of air from the second convection fan 110 to pass through the interior fan guard 302 into a forward area of the cooking chamber 102, while also advantageously preventing objects (e.g., cooking tools, utensils, cookware, human hands, etc.) from coming into contact with the blades 806 of the first convection fan 108 and/or the blades 812 of the second convection fan 110. In the illustrated example, the interior fan guard 302 is coupled to the rear wall 504 of the cookbox 202. In other examples, the interior fan guard 302 can instead be coupled to one or more sidewall(s) (e.g., a right sidewall and/or a left sidewall) of the cookbox 202.

As another example, as shown in FIGS. 5-7 and 11, an example exterior fan guard 502 located externally to the cooking chamber 102 covers and/or protects the electric motor 802 of the first convection fan 108 and/or the electric motor 808 of the second convection fan 110. In the illustrated example, the exterior fan guard 502 is configured as a solid casing. The exterior fan guard 502 is accordingly configured to advantageously prevent objects (e.g., cooking tools, utensils, cookware, human hands, etc.) and/or undesirable weather elements (e.g., rain, snow, etc.) from coming into contact with the electric motor 802 of the first convection fan 108 and/or the electric motor 808 of the second convection fan 110. In the illustrated example, the exterior fan guard 502 is coupled to the rear wall 504 of the cookbox 202. In other examples, the exterior fan guard 502 can instead be coupled to one or more sidewall(s) (e.g., a right sidewall and/or a left sidewall) of the cookbox 202.

The electric grill 100 of FIGS. 2-11 further includes an example frame 208. In the illustrated example of FIGS. 2-11, the frame 208 includes one or more example support member(s) 210 (e.g., one or more vertically oriented leg(s)) that are configured to support the cookbox 202 above an underlying ground surface. The support member(s) 210 and/or, more generally, the frame 208 can be configured from any number and any type of structural components arranged in any manner that facilitates supporting the cookbox 202 above an underlying ground surface when the electric grill 100 is in use. For example, while each of the one or more support member(s) 210 shown in FIGS. 2-11 is fixed relative to the cookbox 202, in other examples the frame 208 can include one or more foldable, slidable, and/or telescoping support member(s) 210 that facilitate collapsing and/or otherwise modifying the frame 208 of the electric grill 100 when the electric grill 100 is not in use. The electric grill 100 of FIGS. 2-11 can further include any number of side tables and/or shelves coupled to the frame 208 and/or to the cookbox 202 of the electric grill 100. As shown in FIGS. 2-4 and 6-8, various input device(s) 130 and/or output device(s) 132 which form part of the user interface 128 of the electric grill 100 can be coupled and/or mounted to the cookbox 202, the lid 204, handle 206, the frame 208, the support member(s) 210, a side table, and/or a shelf of the electric grill 100.

FIG. 12 is a front view of an example second implementation of the electric grill 100 of FIG. 1. In the illustrated example of FIG. 12, the electric grill 100 includes the cooking chamber 102 and the warming cabinet 114 of FIG. 1 described above, but lacks the air fryer 120 of FIG. 1 described above. The warming cabinet 114 of FIG. 12 is coupled to, supported by, and/or carried by the frame 208 of the electric grill 100. As shown in FIG. 12, the warming cabinet 114 of the electric grill 100 is laterally offset from (e.g., located to the right of) the cooking chamber 102 of the electric grill 100. As further shown in FIG. 12, the warming cabinet 114 of the electric grill 100 is generally located below the cooking chamber 102 of the electric grill 100.

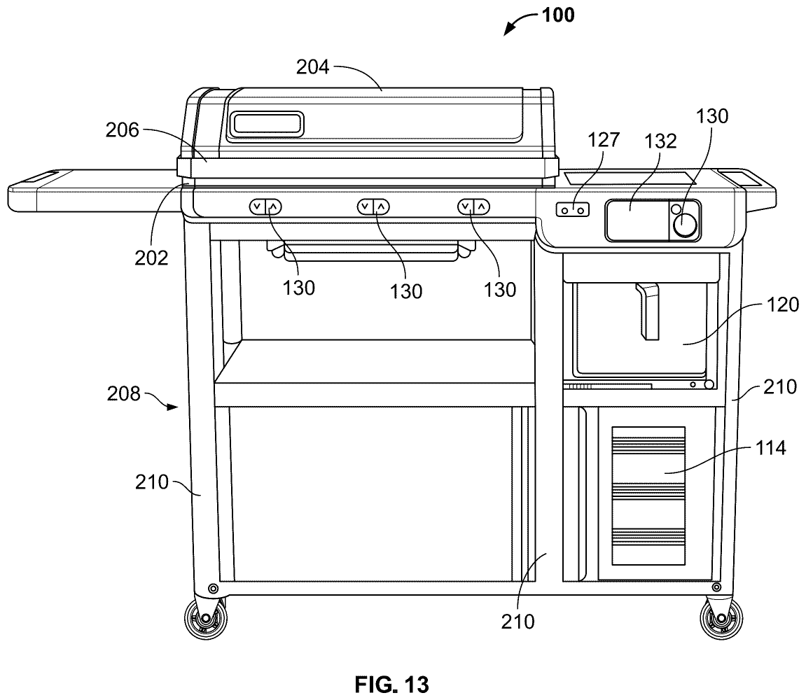

FIG. 13 is a front view of an example third implementation of the electric grill 100 of FIG. 1. In the illustrated example of FIGS. 13, the electric grill 100 includes the cooking chamber 102, the warming cabinet 114, and the air fryer 120 of FIG. 1 described above. The warming cabinet 114 of FIG. 13 is coupled to, supported by, and/or carried by the frame 208 of the electric grill 100. As shown in FIG. 13, the warming cabinet 114 of the electric grill 100 is laterally offset from (e.g., located to the right of) the cooking chamber 102 of the electric grill 100. As further shown in FIG. 13, the warming cabinet 114 of the electric grill 100 is generally located below the cooking chamber 102 of the electric grill 100. The air fryer 120 of FIG. 13 is coupled to, supported by, and/or carried by the frame 208 of the electric grill 100. As shown in FIG. 13, the air fryer 120 of the electric grill 100 is laterally offset from (e.g., located to the right of) the cooking chamber 102 of the electric grill 100, and laterally aligned with the warming cabinet 114 of the electric grill 100. As further shown in FIG. 13, the air fryer 120 of the electric grill 100 is generally located above the warming cabinet 114 of the electric grill 100.

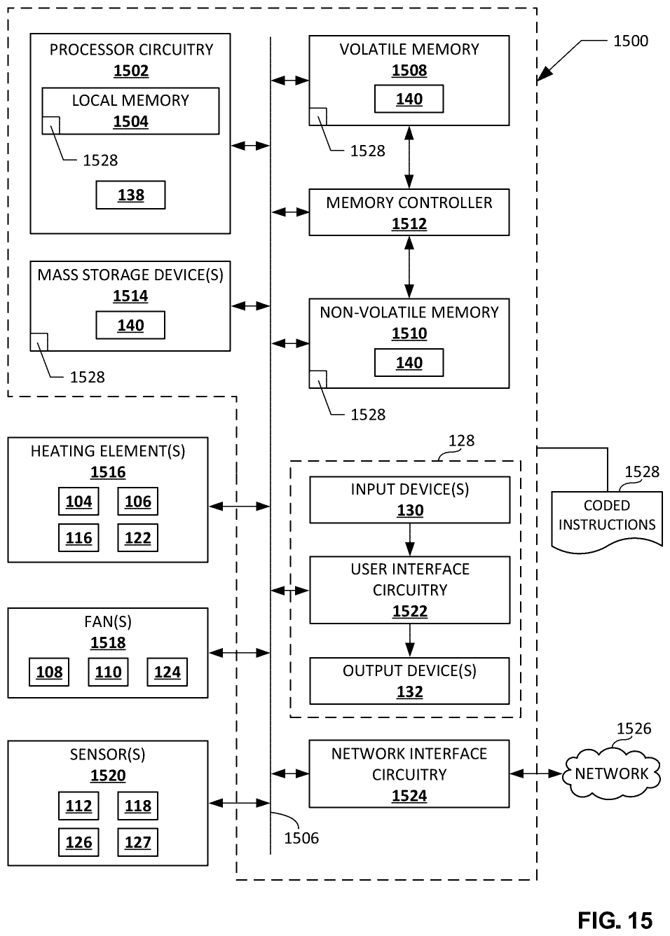

A flowchart representing example machine-readable instructions, which may be executed to configure processor circuitry to implement the electric grill 100 of FIG. 1, is shown in FIG. 14. The machine-readable instructions may be one or more executable program(s) or portion(s) thereof for execution by processor circuitry, such as the processor circuitry 1502 shown in the example processor platform 1500 discussed below in connection with FIG. 15. The program(s) may be embodied in software stored on one or more non-transitory computer readable storage media such as an optical storage device, a magnetic storage device, a floppy disk drive, a hard disk drive (HDD), a solid state storage device, a flash memory, a read-only memory (ROM), a random-access memory (RAM), a volatile memory, a non-volatile memory, a cache, a CD, a DVD, a Blu-ray disk, and/or any other tangible storage device or tangible storage disk associated with processor circuitry located in one or more hardware device(s). Alternatively, the entire program(s) and/or the portion(s) thereof could be executed by one or more hardware device(s) other than the processor circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer-readable storage media may include one or more medium(s) located in one or more hardware device(s). Further, although example programs are described with reference to the flowchart illustrated in FIG. 14, many other methods of implementing the example electric grill 100 of FIG. 1 may alternatively be used. For example, the order of execution of the blocks may be changed, and/or some of the blocks described may be changed, eliminated, or combined. Additionally, or alternatively, any or all of the blocks may be implemented by one or more hardware circuit(s) (e.g., processor circuitry) and/or hardware device(s) structured to perform the corresponding operation(s) without executing software or firmware. The hardware circuit(s) and/or hardware device(s) can be located on a single machine, or can be located across multiple machines in different network locations.

The machine-readable instructions described herein may be stored in one or more of a compressed format, an encrypted format, a fragmented format, a compiled format, an executable format, a packaged format, etc. Machine-readable instructions as described herein may be stored as data or a data structure (e.g., as portions of instructions, code, representations of code, etc.) that may be utilized to create, manufacture, and/or produce machine-executable instructions. For example, the machine-readable instructions may be fragmented and stored on one or more storage device(s) and/or computing device(s) (e.g., one or more server(s)) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or any other machine. For example, the machine-readable instructions may be stored in multiple parts, which are individually compressed, encrypted, and/or stored on separate computing devices, wherein the parts when decrypted, decompressed, and/or combined form a set of machine-executable instructions that implement one or more operation(s) that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or any other device. In another example, the machine-readable instructions may need to be configured (e.g., settings stored, data input, network addresses recorded, etc.) before the machine-readable instructions and/or the corresponding program(s) can be executed in whole or in part. Thus, machine-readable media, as used herein, may include machine-readable instructions and/or program(s) regardless of the particular format or state of the machine-readable instructions and/or program(s) when stored or otherwise at rest or in transit. The machine-readable instructions described herein can be represented by any past, present, or future instruction language, scripting language, programming language, etc. For example, the machine-readable instructions may be represented using any of the following languages: C, C++, C#, Java, JavaScript, Python, Perl, HyperText Markup Language (HTML), Structured Query Language (SQL), Non-relational SQL (NoSQL), Swift, etc.

As mentioned above, the example operations of FIG. 14 may be implemented using executable instructions (e.g., computer and/or machine-readable instructions) stored on one or more non-transitory computer and/or machine-readable media such as an optical storage device, a magnetic storage device, a hard disk drive (HDD), a solid state storage device, a flash memory, a read-only memory (ROM), a random-access memory (RAM), a volatile memory, a non-volatile memory, a cache, a CD, a DVD, a Blu-ray disk, and/or any other tangible storage device or tangible storage disk in which information is stored for any duration (e.g., permanently, for extended time periods, for brief instances, for temporarily buffering, and/or for caching of the information).

FIG. 14 is a flowchart representative of example machine-readable instructions and/or example operations 1400 that may be executed by processor circuitry (e.g., processor circuitry of the controller 138 of FIG. 1) to implement the electric grill 100 of FIG. 1. The machine-readable instructions and/or operations 1400 of FIG. 14 begin at Block 1402 when the processor circuitry of the controller 138 of FIG. 1 determines whether one or more control input(s) associated with one or more operation(s) of the electric grill 100 of FIG. 1 has/have been received. For example, the processor circuitry of the controller 138 can determine whether the user interface 128 and/or the network interface 134 of the electric grill 100 of FIG. 1 has/have received any commands, instructions, signals, inputs, and/or other data indicative of a control input associated with an operation of the electric grill 100 (e.g., a desired ON/OFF state, a desired temperature, a desired fan speed, a desired cooking, warming, or air frying mode, a desired cooking, warming, or air frying recipe, a desired cooking, warming, or air frying program, and/or any other state, setting, selection, mode, or program pertaining to an operation of the electric grill 100). If the processor circuitry of the controller 138 determines at Block 1402 that one or more control input(s) associated with one or more operation(s) of the electric grill 100 has/have been received, control of the machine-readable instructions and/or operations 1400 of FIG. 14 proceeds to Block 1404. If the processor circuitry of the controller 138 instead determines at Block 1402 that no control input associated with an operation of the electric grill 100 has been received, control of the machine-readable instructions and/or operations 1400 of FIG. 14 remains at Block 1402.

At Block 1404, the processor circuitry of the controller 138 of FIG. 1 determines whether any of the received control input(s) is/are associated with one or more operation(s) of the cooking chamber 102 of the electric grill 100 of FIG. 1. For example, the processor circuitry of the controller 138 can determine whether any of the received control input(s) is/are associated with one or more operation(s) of the first heating element 104, the second heating element 106, the first convection fan 108, and/or the second convection fan 110 of the cooking chamber 102 of the electric grill 100 (e.g., a desired ON/OFF state, a desired temperature, a desired fan speed, a desired cooking mode, a desired cooking recipe, a desired cooking program, and/or any other state, setting, selection, mode, or program pertaining to an operation of the first heating element 104, the second heating clement 106, the first convection fan 108, and/or the second convection fan 110 of the cooking chamber 102 of the electric grill 100). If the processor circuitry of the controller 138 determines at Block 1404 that one or more of the received control input(s) is/are associated with one or more operation(s) of the cooking chamber 102 of the electric grill 100, control of the machine-readable instructions and/or operations 1400 of FIG. 14 proceeds to Block 1406. If the processor circuitry of the controller 138 instead determines at Block 1404 that no received control input is associated with an operation of the cooking chamber 102 of the electric grill 100, control of the machine-readable instructions and/or operations 1400 of FIG. 14 proceeds to Block 1408.

At Block 1406, the processor circuitry of the controller 138 of FIG. 1 commands, instructs, signals, and/or otherwise causes one or more of the heating element(s) (e.g., the first heating element 104 and/or the second heating element 106) and/or one or more of the convection fan(s) (e.g., the first convection fan 108 and/or the second convection fan 110) of the cooking chamber 102 of FIG. 1 to operate in a manner that corresponds to, achieves, and/or otherwise implements respective ones of the received control input(s) which the processor circuitry of the controller 138 determined at Block 1404 to be associated with the operation(s) of the cooking chamber 102 of the electric grill 100. In some examples, the processor circuitry of the controller 138 independently controls the heating element(s) and/or the convection fan(s) of the cooking chamber 102 in connection with executing and/or performing Block 1406. In some examples, the execution and/or performance of Block 1406 by the processor circuitry of the controller 138 is based in part on temperature data sensed, measured, detected, and/or otherwise obtained by or from the temperature sensor 112 of the cooking chamber 102 of the electric grill 100. For example, the processor circuitry of the controller 138 may consider and/or utilize such temperature data as an input to a control loop (e.g., a feedback input to a PID control loop) implemented by the processor circuitry of the controller 138 in connection with the execution and/or performance of Block 1406. Following Block 1406, control of the machine-readable instructions and/or operations 1400 of FIG. 14 proceeds to Block 1408.

At Block 1408, the processor circuitry of the controller 138 of FIG. 1 determines whether any of the received control input(s) is/are associated with one or more operation(s) of the warming cabinet 114 of the electric grill 100 of FIG. 1. For example, the processor circuitry of the controller 138 can determine whether any of the received control input(s) is/are associated with one or more operation(s) of the heating element 116 of the warming cabinet 114 of the electric grill 100 (e.g., a desired ON/OFF state, a desired temperature, a desired warming mode, a desired warming recipe, a desired warming program, and/or any other state, setting, selection, mode, or program pertaining to an operation of the heating element 116 of the warming cabinet 114 of the electric grill 100). If the processor circuitry of the controller 138 determines at Block 1408 that one or more of the received control input(s) is/are associated with one or more operation(s) of the warming cabinet 114 of the electric grill 100, control of the machine-readable instructions and/or operations 1400 of FIG. 14 proceeds to Block 1410. If the processor circuitry of the controller 138 instead determines at Block 1408 that no received control input is associated with an operation of the warming cabinet 114 of the electric grill 100, control of the machine-readable instructions and/or operations 1400 of FIG. 14 proceeds to Block 1412.

At Block 1410, the processor circuitry of the controller 138 of FIG. 1 commands, instructs, signals, and/or otherwise causes the heating element 116 of the warming cabinet 114 of FIG. 1 to operate in a manner that corresponds to, achieves, and/or otherwise implements respective ones of the received control input(s) which the processor circuitry of the controller 138 determined at Block 1408 to be associated with the operation(s) of the warming cabinet 114 of the electric grill 100. In some examples, the processor circuitry of the controller 138 independently controls the heating element 116 of the warming cabinet 114 in connection with executing and/or performing Block 1410. In some examples, the execution and/or performance of Block 1410 by the processor circuitry of the controller 138 is based in part on temperature data sensed, measured, detected, and/or otherwise obtained by or from the temperature sensor 118 of the warming cabinet 114 of the electric grill 100. For example, the processor circuitry of the controller 138 may consider and/or utilize such temperature data as an input to a control loop (e.g., a feedback input to a PID control loop) implemented by the processor circuitry of the controller 138 in connection with the execution and/or performance of Block 1410. Following Block 1410, control of the machine-readable instructions and/or operations 1400 of FIG. 14 proceeds to Block 1412.

At Block 1412, the processor circuitry of the controller 138 of FIG. 1 determines whether any of the received control input(s) is/are associated with one or more operation(s) of the air fryer 120 of the electric grill 100 of FIG. 1. For example, the processor circuitry of the controller 138 can determine whether any of the received control input(s) is/are associated with one or more operation(s) of the heating element 122 and/or the convection fan 124 of the air fryer 120 of the electric grill 100 (e.g., a desired ON/OFF state, a desired temperature, a desired fan speed, a desired air frying mode, a desired air frying recipe, a desired air frying program, and/or any other state, setting, selection, mode, or program pertaining to an operation of the heating element 122 and/or the convection fan 124 of the air fryer 120 of the electric grill 100). If the processor circuitry of the controller 138 determines at Block 1412 that one or more of the received control input(s) is/are associated with one or more operation(s) of the air fryer 120 of the electric grill 100, control of the machine-readable instructions and/or operations 1400 of FIG. 14 proceeds to Block 1412. If the processor circuitry of the controller 138 instead determines at Block 1412 that no received control input is associated with an operation of the air fryer 120 of the electric grill 100, control of the machine-readable instructions and/or operations 1400 of FIG. 14 proceeds to Block 1416.

At Block 1414, the processor circuitry of the controller 138 of FIG. 1 commands, instructs, signals, and/or otherwise causes the heating element 122 and/or the convection fan 124 of the air fryer 120 of FIG. 1 to operate in a manner that corresponds to, achieves, and/or otherwise implements respective ones of the received control input(s) which the processor circuitry of the controller 138 determined at Block 1412 to be associated with the operation(s) of the air fryer 120 of the electric grill 100. In some examples, the processor circuitry of the controller 138 independently controls the heating element 122 and/or the convection fan 124 of the air fryer 120 in connection with executing and/or performing Block 1414. In some examples, the execution and/or performance of Block 1414 by the processor circuitry of the controller 138 is based in part on temperature data sensed, measured, detected, and/or otherwise obtained by or from the temperature sensor 126 of the air fryer 120 of the electric grill 100. For example, the processor circuitry of the controller 138 may consider and/or utilize such temperature data as an input to a control loop (e.g., a feedback input to a PID control loop) implemented by the processor circuitry of the controller 138 in connection with the execution and/or performance of Block 1414. Following Block 1414, control of the machine-readable instructions and/or operations 1400 of FIG. 14 proceeds to Block 1416.

At Block 1416, the processor circuitry of the controller 138 of FIG. 1 determines whether to continue operating the electric grill 100. For example, the processor circuitry of the controller 138 can determine whether the user interface 128 and/or the network interface 134 of the electric grill 100 of FIG. 1 has/have received any commands, instructions, signals, inputs, and/or other data indicative of a request to terminate the process and/or protocol of FIG. 14, and/or more generally, to cease operating the electric grill 100. If the processor circuitry of the controller 138 determines at Block 1416 that the process and/or protocol of FIG. 14 is to continue (e.g., that no termination request has been received), control of the machine-readable instructions and/or operations 1400 of FIG. 14 returns to Block 1402. If the processor circuitry of the controller 138 instead determines at Block 1416 that the process and/or protocol of FIG. 14 is to cease or terminate (e.g., that a termination request has been received), the machine-readable instructions and/or operations 1400 of FIG. 14 end.

The above-described process and/or protocol of FIG. 14 is illustrative of an embodiment of the electric grill 100 of FIG. 1 that includes the cooking chamber 102, the warming cabinet 114, and the air fryer 120 of FIG. 1. In other embodiments in which the warming cabinet 114 and/or the air fryer 120 is/are omitted from the electric grill 100 of FIG. 1, the above-described process and/or protocol of FIG. 14 can be modified accordingly. For example, in connection with an embodiment of the electric grill 100 that includes the cooking chamber 102 but omits both the warming cabinet 114 and the air fryer 120, the process and/or protocol of FIG. 14 can be modified such that Block 1408, Block 1410, Block 1412, and Block 1414 are eliminated and/or omitted from the machine-readable instructions and/or operations 1400 of FIG. 14, and such that the output(s) of Block 1404 and/or Block 1406 proceed to Block 1416 rather than to Block 1408. As another example, in connection with an embodiment of the electric grill 100 that includes the cooking chamber 102 and the warming cabinet 114 but omits the air fryer 120, the process and/or protocol of FIG. 14 can be modified such that Block 1412 and Block 1414 are eliminated and/or omitted from the machine-readable instructions and/or operations 1400 of FIG. 14, and such that the output(s) of Block 1408 and/or Block 1410 proceed to Block 1416 rather than to Block 1412.

FIG. 15 is a block diagram of an example processor platform 1500 including processor circuitry structured to execute and/or instantiate the machine-readable instructions and/or operations 1400 of FIG. 14 to implement the electric grill 100 of FIG. 1. The processor platform 1500 of the illustrated example includes processor circuitry 1502. The processor circuitry 1502 of the illustrated example is hardware. For example, the processor circuitry 1502 includes any type(s) and/or any number(s) of processor(s), microprocessor(s), controller(s), microcontroller(s), ASIC(s), PLD(s), FPLD(s), FPGA(s), DSP(s), GPU(s), CPU(s), semiconductor-based (e.g., silicon-based) circuit(s), digital circuit(s), analog circuit(s), logic circuit(s), and/or integrated circuit(s) implemented by any type(s) and/or any number(s) of transistor(s), capacitor(s), diode(s), inductor(s), resistor(s), timer(s), counter(s), printed circuit board(s), connector(s), wire(s), and/or other electrical circuit component(s). In this example, the processor circuitry 1502 implements the controller 138 of FIG. 1.

The processor circuitry 1502 of the illustrated example includes a local memory 1504 (e.g., a cache, registers, etc.). The processor circuitry 1502 is in electrical communication with a main memory via a bus 1506, with the main memory including a volatile memory 1508 and a non-volatile memory 1510. The volatile memory 1508 may be implemented by any type of random-access memory (RAM) (e.g., Synchronous Dynamic Random Access Memory (SDRAM), Dynamic Random Access Memory (DRAM), RAMBUS® Dynamic Random Access Memory (RDRAM®), etc.). The non-volatile memory 1510 may be implemented by flash memory and/or any other desired type of memory device. Access to the main memory 1508, 1510 of the illustrated example is controlled by a memory controller 1512.

The processor platform 1500 of the illustrated example also includes one or more mass storage device(s) 1514 to store software and/or data. Examples of such mass storage device(s) 1514 include an optical storage device, a magnetic storage device, a floppy disk drive, a hard disk drive (HDD), a solid state storage device, a flash memory device, a read-only memory (ROM), a random-access memory (RAM), a cache, a CD, a DVD, a Blu-ray disk, and/or any other tangible storage device or tangible storage disk in which information is stored for any duration (e.g., permanently, for extended time periods, for brief instances, for temporarily buffering, and/or for caching of the information). In the illustrated example of FIG. 15, one or more of the volatile memory 1508, the non-volatile memory 1510, and/or the mass storage device(s) 1514 implement(s) the memory 140 of FIG. 1.

The processor circuitry 1502 is also in electrical communication with one or more heating element(s) 1516 via the bus 1506. In this example, the heating clement(s) 1516 include the first heating element 104 and the second heating element 106 of the cooking chamber 102 of FIG. 1, the heating element 116 of the warming cabinet 114 of FIG. 1, and the heating element 122 of the air fryer 120 of FIG. 1. The processor circuitry 1502 is also in electrical communication with one or more fan(s) 1518 via the bus 1506. In this example, the fan(s) 4218 include the first convection fan 108 and the second convection fan 110 of the cooking chamber 102 of FIG. 1, and the convection fan 124 of the air fryer 120 of FIG. 1. The processor circuitry 1502 is also in electrical communication with one or more sensor(s) 1520 via the bus 1506. In this example, the sensor(s) 1520 include the temperature sensor 112 of the cooking chamber 102 of FIG. 1, the temperature sensor 118 of the warming cabinet 114 of FIG. 1, the temperature sensor 126 of the air fryer 120 of FIG. 1, and the temperature probe hub 127 of FIG. 1.

The processor platform 1500 of the illustrated example also includes user interface circuitry 1522. The user interface circuitry 1522 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. In the illustrated example, one or more input device(s) 130 are connected to the user interface circuitry 1522. The input device(s) 130 permit(s) a user to enter data and/or commands into the processor circuitry 1502. The input device(s) 130 can be implemented, for example, by one or more of a touchscreen, a button, a dial, a knob, a switch, an audio sensor, a microphone, an image sensor, a camera, and/or a voice recognition system. One or more output device(s) 132 are also connected to the user interface circuitry 1522 of the illustrated example. The output device(s) 132 can be implemented, for example, by one or more of a display device (e.g., a light emitting diode (LED), an organic light emitting diode (OLED), a liquid crystal display (LCD), a cathode ray tube (CRT) display, an in-plane switching (IPS) display, a touchscreen, etc.), a tactile output device, and/or a speaker. The user interface circuitry 1522 of the illustrated example, thus, typically includes a graphics driver card, a graphics driver chip, and/or graphics processor circuitry such as a GPU. In the illustrated example of FIG. 15, the user interface circuitry 1522, the input device(s) 130, and the output device(s) 132 collectively implement the user interface 128 of FIG. 1.

The processor platform 1500 of the illustrated example also includes network interface circuitry 1524. The network interface circuitry 1524 includes one or more communication device(s) (e.g., transmitter(s), receiver(s), transceiver(s), modem(s), gateway(s), wireless access point(s), etc.) to facilitate exchange of data with external machines (e.g., computing devices of any kind, including the remote device(s) 146 of FIG. 1) by a network 1526. The communication can be by, for example, a satellite system, a wireless system, a cellular telephone system, an Ethernet connection, a digital subscriber line (DSL) connection, a telephone line connection, a coaxial cable system, an optical connection, etc. In the illustrated example of FIG. 15, the network interface circuitry 1524 implements the network interface 134 (e.g., including the communication device(s) 136) of FIG. 1.

Coded instructions 1528 including the above-described machine-readable instructions and/or operations 1400 of FIG. 14 may be stored in the local memory 1504, in the volatile memory 1508, in the non-volatile memory 1510, on the mass storage device(s) 1514, and/or on a removable non-transitory computer-readable storage medium such as a flash memory stick, a dongle, a CD, a DVD, or a Blu-ray disk.

The following paragraphs provide various examples in relation to the disclosed electric grills including convection fans.

Example 1 includes an electric grill. In Example 1, the electric grill includes a cookbox, a lid, a cooking chamber, a cooking grate, a first heating element, a second heating element, a first convection fan, and a second convection fan. The cookbox includes a rear wall. The lid is movable relative to the cookbox between a closed position and an open position. The cooking chamber is defined by the cookbox and the lid. The cooking grate is located within the cooking chamber. The first heating element is located within the cooking chamber below the cooking grate. The second heating element is located within the cooking chamber below the cooking grate. The second heating element is laterally offset from the first heating element. The first convection fan is coupled to the rear wall of the cookbox. The first convection fan is located above the first heating element and at least partially within the cooking chamber. The second convection fan is coupled to the rear wall of the cookbox. The second convection fan is located above the second heating element and at least partially within the cooking chamber. The second convection fan is laterally offset from the first convection fan.

Example 2 includes the electric grill of Example 1. In Example 2, the electric grill further includes a controller in electrical communication with the first heating element, the second heating element, the first convection fan, and the second convection fan. The controller is configured to independently control the first heating element, the second heating element, the first convection fan, and the second convection fan.

Example 3 includes the electric grill of Example 1. In Example 3, the electric grill further includes a power supply configured to supply electric power to the first heating element, the second heating element, the first convection fan, and the second convection fan.

Example 4 includes the electric grill of Example 1. In Example 4, the first convection fan and the second convection fan are located above the cooking grate.

Example 5 includes the electric grill of Example 1. In Example 5, the first convection fan is laterally aligned with the first heating element, and the second convection fan is laterally aligned with the second heating element.

Example 6 includes the electric grill of Example 1. In Example 6, the first heating element and the first convection fan provide a first controllable cooking zone within the cooking chamber, and the second heating element and the second convection fan provide a second controllable cooking zone within the cooking chamber. The second controllable cooking zone is laterally offset from the first controllable cooking zone.

Example 7 includes the electric grill of Example 1. In Example 7, the cookbox supports the cooking grate, the first heating element, the second heating element, the first convection fan, and the second convection fan.

Example 8 includes the electric grill of Example 1. In Example 8, the first convection fan includes a first plurality of blades located within the cooking chamber, and the second convection fan includes a second plurality of blades located within the cooking chamber.

Example 9 includes the electric grill of Example 8. In Example 9, the electric grill further includes an interior fan guard located within the cooking chamber. The interior fan guard is configured to cover at least one of the first plurality of blades of the first convection fan or the second plurality of blades of the second convection fan.

Example 10 includes the electric grill of Example 9. In Example 10, the interior fan guard is coupled to the rear wall of the cookbox.

Example 11 includes the electric grill of Example 8. In Example 11, the first convection fan includes a first motor located at least partially outside of the cooking chamber, and the second convection fan includes a second motor located at least partially outside of the cooking chamber.

Example 12 includes the electric grill of Example 11. In Example 12, the electric grill further includes an exterior fan guard located externally to the cooking chamber. The exterior fan guard is configured to cover at least one of the first motor of the first convection fan or the second motor of the second convection fan.

Example 13 includes the electric grill of Example 12. In Example 13, the exterior fan guard is coupled to the rear wall of the cookbox.

Example 14 includes the electric grill of Example 11. In Example 14, a portion of the first convection fan and a portion of the second convection fan respectively extend through the rear wall of the cookbox.

Example 15 includes the electric grill of Example 1. In Example 15, the electric grill further includes a warming cabinet and a heating element. The warming cabinet is spaced apart and thermally isolated from the cooking chamber. The heating element is located within the warming cabinet.

Example 16 includes the electric grill of Example 15. In Example 15, the electric grill further includes a controller in electrical communication with the first heating element, the second heating element, the first convection fan, and the second convection fan of the cooking chamber, and further in electrical communication with the heating element of the warming cabinet. The controller is configured to independently control the first heating element, the second heating element, the first convection fan, and the second convection fan of the cooking chamber, and to further independently control the heating element of the warming cabinet.

Example 17 includes the electric grill of Example 16. In Example 17, at least one of the first heating element, the second heating element, the first convection fan, or the second convection fan of the cooking chamber is concurrently operable with the heating element of the warming cabinet.

Example 18 includes the electric grill of Example 1. In Example 18, the electric grill further includes an air fryer, a heating element, and a convection fan. The air fryer is spaced apart and thermally isolated from the cooking chamber. The heating element is located within the air fryer. The convection fan is located at least partially within the air fryer.

Example 19 includes the electric grill of Example 18. In Example 19, the electric grill further includes a controller in electrical communication with the first heating element, the second heating element, the first convection fan, and the second convection fan of the cooking chamber, and further in electrical communication with the heating element and the convection fan of the air fryer. The controller is configured to independently control the first heating element, the second heating element, the first convection fan, and the second convection fan of the cooking chamber, and to further independently control the heating element and the convection fan of the air fryer.

Example 20 includes the electric grill of Example 19. In Example 20, at least one of the first heating element, the second heating element, the first convection fan, or the second convection fan of the cooking chamber is concurrently operable with at least one of the heating element or the convection fan of the air fryer.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. An electric grill, comprising:
a cookbox including a rear wall;
a lid movable relative to the cookbox between a closed position and an open position;
a cooking chamber defined by the cookbox and the lid;
a cooking grate located within the cooking chamber;
a first heating element located within the cooking chamber below the cooking grate;
a second heating element located within the cooking chamber below the cooking grate, the second heating element laterally offset from the first heating element;
a first convection fan coupled to the rear wall of the cookbox, the first convection fan located above the first heating element and at least partially within the cooking chamber; and
a second convection fan coupled to the rear wall of the cookbox, the second convection fan located above the second heating element and at least partially within the cooking chamber, the second convection fan laterally offset from the first convection fan.

2. The electric grill of claim 1, further comprising a controller in electrical communication with the first heating element, the second heating element, the first convection fan, and the second convection fan, the controller configured to independently control the first heating element, the second heating element, the first convection fan, and the second convection fan.

3. The electric grill of claim 1, further comprising a power supply configured to supply electric power to the first heating element, the second heating element, the first convection fan, and the second convection fan.

4. The electric grill of claim 1, wherein the first convection fan and the second convection fan are located above the cooking grate.

5. The electric grill of claim 1, wherein the first convection fan is laterally aligned with the first heating element, and the second convection fan is laterally aligned with the second heating element.

6. The electric grill of claim 1, wherein the first heating element and the first convection fan provide a first controllable cooking zone within the cooking chamber, and the second heating element and the second convection fan provide a second controllable cooking zone within the cooking chamber, the second controllable cooking zone laterally offset from the first controllable cooking zone.

7. The electric grill of claim 1, wherein the cookbox supports the cooking grate, the first heating element, the second heating element, the first convection fan, and the second convection fan.

8. The electric grill of claim 1, wherein the first convection fan includes a first plurality of blades located within the cooking chamber, and the second convection fan includes a second plurality of blades located within the cooking chamber.

9. The electric grill of claim 8, further comprising an interior fan guard located within the cooking chamber, the interior fan guard configured to cover at least one of the first plurality of blades of the first convection fan or the second plurality of blades of the second convection fan.

10. The electric grill of claim 9, wherein the interior fan guard is coupled to the rear wall of the cookbox.

11. The electric grill of claim 8, wherein the first convection fan includes a first motor located at least partially outside of the cooking chamber, and the second convection fan includes a second motor located at least partially outside of the cooking chamber.

12. The electric grill of claim 11, further comprising an exterior fan guard located externally to the cooking chamber, the exterior fan guard configured to cover at least one of the first motor of the first convection fan or the second motor of the second convection fan.

13. The electric grill of claim 12, wherein the exterior fan guard is coupled to the rear wall of the cookbox.

14. The electric grill of claim 11, wherein a portion of the first convection fan and a portion of the second convection fan respectively extend through the rear wall of the cookbox.

15. The electric grill of claim 1, further comprising:
a warming cabinet spaced apart and thermally isolated from the cooking chamber; and
a heating element located within the warming cabinet.

16. The electric grill of claim 15, further comprising a controller in electrical communication with the first heating element, the second heating element, the first convection fan, and the second convection fan of the cooking chamber, and further in electrical communication with the heating element of the warming cabinet, the controller configured to independently control the first heating element, the second heating element, the first convection fan, and the second convection fan of the cooking chamber, and to further independently control the heating element of the warming cabinet.

17. The electric grill of claim 16, wherein at least one of the first heating element, the second heating element, the first convection fan, or the second convection fan of the cooking chamber is concurrently operable with the heating element of the warming cabinet.

18. The electric grill of claim 1, further comprising:
an air fryer spaced apart and thermally isolated from the cooking chamber;
a heating element located within the air fryer; and
a convection fan located at least partially within the air fryer.

19. The electric grill of claim 18, further comprising a controller in electrical communication with the first heating element, the second heating element, the first convection fan, and the second convection fan of the cooking chamber, and further in electrical communication with the heating element and the convection fan of the air fryer, the controller configured to independently control the first heating element, the second heating element, the first convection fan, and the second convection fan of the cooking chamber, and to further independently control the heating element and the convection fan of the air fryer.

20. The electric grill of claim 19, wherein at least one of the first heating element, the second heating element, the first convection fan, or the second convection fan of the cooking chamber is concurrently operable with at least one of the heating element or the convection fan of the air fryer.
